(19) United States
(12) Patent Application Publication
(10) Pub. No.: US 2023/0225947 A1
(43) Pub. Date: Jul. 20, 2023

(54) PILL DISPENSER DEVICE, SYSTEM, AND METHOD

(71) Applicant: MODOSCRIPT, INC., Roslindale, MA (US)

(72) Inventors: David Zuleta, Roslindale, MA (US); Tim Fensterer, Winter Park, FL (US); Jordan Shoemake, Cincinnati, OH (US); Justin Niemeier, Bloomingdale, NJ (US); Alexander Gorshkov, Somerville, NJ (US); Robert Boyer, Boonton, NJ (US)

(21) Appl. No.: 18/175,410

(22) Filed: Feb. 27, 2023

Related U.S. Application Data
(63) Continuation-in-part of application No. 16/964,961, filed on Jul. 24, 2020.
(60) Provisional application No. 63/314,131, filed on Feb. 25, 2022.
(60) Provisional application No. 62/621,931, filed on Jan. 25, 2018.

(51) Int. Cl. A61J 7/04; G06F 21/32; G06F 21/44

(52) U.S. Cl. CPC A61J 7/0481; A61J 7/0418; G06F 21/32; G06F 21/44; A61J 2200/70

(57) ABSTRACT

A dosage unit dispenser cap in communication with a biometric sensing module is disclosed. The dosage unit dispenser cap includes a housing adapted to mate with a standard prescription dram vial, a dispensing port, and a computer processor. A dosage unit dispenser system including the dosage unit dispenser cap and the standard prescription dram vial is also disclosed. A system for patient treatment and monitoring including the dosage unit dispenser cap in communication with the biometric sensing module, a central database, and a dispensing system platform is also disclosed. A method of facilitating distribution of a dosage unit by providing the dosage unit dispenser cap is also disclosed.

### CROSS-REFERENCE TO RELATED APPLICATIONS

This application is a Continuation-In-Part of U.S. Non-Provisional Application No. 16/964,961, titled “PILL DISPENSER DEVICE, SYSTEM, AND METHOD” filed Jul. 24, 2020, and also claims priority under 35 U.S.C. §119(e) to U.S. Provisional Patent Application No. 63/314,131 titled “PILL DISPENSER DEVICE, SYSTEM, AND METHOD” filed Feb. 25, 2022, the entire disclosure of each of which is herein incorporated by reference in its entirety for all purposes.

### FIELD OF TECHNOLOGY

The disclosure pertains to the field of pill dispensers, and more particularly, to a tamper-proof pill dispenser apparatus and system.

### SUMMARY

In accordance with one aspect, there is provided a dosage unit dispenser cap. The dosage unit dispenser cap may be in communication with a biometric sensing module comprising at least one biometric sensor configured to collect biological data of a user including identity verification data and health data. The dosage unit dispenser cap may comprise a housing defining an open-ended cavity configured to mate with a standard prescription dram vial forming an internal storage cavity loaded with the dosage unit. The dosage unit dispenser cap may comprise a dispensing port on the housing to dispense the dosage unit from the internal storage cavity, the dispensing port locked by a locking element and configured to be enabled to dispense the dosage unit by the user responsive to activation of the biometric sensor verification of the identity of the user and on a predetermined schedule. The dosage unit dispenser cap may comprise a computer processor supported by the housing in communication with the biometric sensing module, a memory that stores the biological data of the user, and a communication element that receives authorized instruction including the predetermined schedule.

In some embodiments, the at least one biometric sensor is supported by the housing.

In some embodiments, the at least one biometric sensor is a wearable device or a mobile device.

In some embodiments, the housing is configured to lock with the standard prescription dram vial.

The dosage unit dispenser cap may further comprise a vial adapter configured to mate the standard prescription dram vial with the open-ended cavity of the housing.

In some embodiments, the vial adapter is dimensioned to mate with a selected size of the standard prescription dram vial and interchangeable with another vial adapter.

In some embodiments, the vial adapter is variable to mate with more than one size of the standard prescription dram vial.

In some embodiments, the dosage unit dispenser cap is in communication with one biometric sensor configured to collect the biological data of the user including both the identity verification data and the health data.

In some embodiments, the dosage unit dispenser cap is in communication with at least two biometric sensors configured to collect the biological data of the user including the identity verification data and the health data.

In some embodiments, the biometric sensor may be one or more of a touch-activated biometric sensor, a sound-activated biometric sensor, a visual biometric sensor, and a breath particulate biometric sensor.

In some embodiments, the touch-activated biometric sensor is capable of sensing one or more of: fingerprint, heart rate, blood oxygen saturation, breathing rate, temperature, blood glucose level, skin capacitance, and viral or respiratory infection or a symptom thereof.

In some embodiments, the sound-activated biometric sensor is capable of sensing one or more of: voice and breathing pattern.

In some embodiments, the visual biometric sensor is capable of sensing one or more of ocular, facial, or other features, and temperature.

In some embodiments, the breath particulate biometric sensor is capable of sensing one or more of: blood alcohol content (BAC), tetrahydrocannabinol (THC) content, blood glucose level, and viral or other pathogenic load.

In some embodiments, the memory is a cloud-based data storage.

In some embodiments, the memory is a local memory storage device supported by the housing.

In some embodiments, the communication element is supported by the housing. The communication element may be configured to facilitate communication between the computer processor and a central database by direct connection or wirelessly over cellular network, provider network, local area network, personal area network, or other wireless network, the central database being in communication with a dispensing system platform configured to transmit the authorized instruction including the predetermined schedule to the communication element.

In some embodiments, the communication element is configured to transmit data to the central database.

In some embodiments, the data includes one or more of the biological data, behavioral data, dosage unit dispensing data, and medication treatment progress data.

In some embodiments, the central database is in communication with a dispensing system platform configured to notify the administrator to review the data and/or revise the authorized instruction responsive to the data.

In some embodiments, the communication element is configured to receive data.

In some embodiments, the data includes the authorized instruction and the central database is in communication with a dispensing system platform configured to notify the user of the authorized instruction.

In some embodiments, the dosage unit dispenser cap comprises a dispensing mechanism in communication with the computer processor configured to selectively direct a predetermined number of the dosage unit to the dispensing port.

In some embodiments, the dispensing mechanism is dimensioned to correspond with one or more selected pill sizes.

In some embodiments, the one or more selected pill sizes are selected from 5 to 000.

In some embodiments, the dispensing mechanism is interchangeable with another dispensing mechanism.

In some embodiments, the dispensing mechanism is configured to selectively direct one dosage unit to the dispensing port.

In some embodiments, the dispensing mechanism comprises an adapter configured to selectively direct the predetermined number of dosage units to a stage car in communication with the dispensing port.

In some embodiments, the dispensing mechanism is operatively connected to a motor configured to rotate the dispensing mechanism delivering the predetermined number of dosage units to the dispensing port.

In some embodiments, the dosage unit dispenser cap further comprises a rotational sensor in communication with the computer processor and configured to determine clocking of the dispensing mechanism.

In some embodiments, the dosage unit dispenser cap further comprises a load sensor in communication with the computer processor and configured to determine if the dispensing mechanism has loaded the predetermined number of dosage units.

In some embodiments, the dosage unit dispenser cap further comprises a rechargeable power source supported by the housing operatively connected to the motor.

The dosage unit dispenser cap may further comprise an indication element comprising one or more of a light, a speaker, and a vibration element supported by the housing, the indication element in communication with the computer processor.

The dosage unit dispenser cap may further comprise at least one of a speaker and a microphone supported by the housing and in communication with the computer processor.

The dosage unit dispenser cap may further comprise an emergency mechanical dispensing element configured to dispense the medicine as a result of mechanical actuation.

The dosage unit dispenser cap may further comprise an electronic display screen.

In some embodiments, the electronic display screen is supported by the housing and in communication with the computer processor.

In some embodiments, the electronic display screen is configured to display at least a portion of the authorized instruction.

In some embodiments, the authorized instruction displayed includes information associated with the predetermined schedule and/or information associated with a predetermined dosage.

In some embodiments, the electronic display screen is configured to display identification information for the dosage unit.

In some embodiments, the identification information includes one or more of an image of the dosage unit, a name of the dosage unit, a description of the dosage unit, and/or a disease, condition, or symptom treatable by administration of the dosage unit.

The dosage unit dispenser cap may comprise a two-step locking element including a primary locking element and a secondary locking element, the primary locking element and the secondary locking element configured to lock the cap to the vial.

The dosage unit dispenser cap may further comprise an indicator, wherein the computer processor is configured to activate the indicator upon engagement of the primary locking element, the primary locking element is configured to be unlocked manually and the secondary locking element is configured to be unlocked with a key.

The dosage unit dispenser cap may further comprise a limit switch sensor configured to detect tampering with one or more of the cap, the vial, the primary locking element, the secondary locking element and/or the dispensing port locking element.

In some embodiments, the dosage unit is a medication or health supplement.

In some embodiments, the dosage unit is a controlled substance.

In some embodiments, the dosage unit is a pill, tablet, capsule, chewable or edible, dissolvable, or liquid dosage form.

In accordance with another aspect, there is provided a system for patient treatment and monitoring. The system may comprise a dosage unit dispensing device in communication with a biometric sensing module comprising at least one biometric sensor configured to collect biological data of a user. The system may comprise a central database in communication with the dosage unit dispensing device and the biometric sensing module, the central database storing the biological data of the user, dosage unit dispensing data of the user, and historical data. The system may comprise a dispensing system platform in communication with the central database, the dosage unit dispensing device, and the biometric sensing module. The dispensing system platform may be programmed to recommend a predetermined treatment plan responsive to the biological data of the user and the historical data. The dispensing system platform may be programmed to transmit an authorized instruction including the predetermined treatment plan to the dosage unit dispensing device.

In some embodiments, the at least one biometric sensor is supported by a housing of the dosage unit dispensing device.

In some embodiments, the at least one biometric sensor is a wearable device or a mobile device.

In some embodiments, the dosage unit dispensing device comprises a communication element connectable to the central database by a cellular network.

In some embodiments, the dosage unit dispensing device comprises a communication element connectable to the central database by a provider network.

In some embodiments, the dosage unit dispensing device comprises a communication element connectable to the central database by a local area network or personal area network of a computing device.

In some embodiments, the biological data of the user comprises one or more of heart rate or irregular rhythm, cardiac electrical signals, skin temperature, body temperature, skin conductance, sweat rate, breath particulates, oxygen saturation, and voice characteristics.

In some embodiments, the central database further stores supplemental data of the user comprising one or more of age, body mass index (BMI), medical history (e.g., comorbidities, chronic conditions, allergies, adverse reactions), family history, genetic information, geographic location (e.g., home location or current location), current or past dosage or medication regiment, concurrent medications, previous positive outcomes, lifestyle factors (e.g., diet, exercise, sleep patterns, stress levels), symptoms (e.g., side effects, pain score, energy levels), and mental health.

In some embodiments, the dispensing system platform is programmed to provide a predicted treatment outcome responsive to the biological data of the user, the supplemental data of the user, and the historical data.

In accordance with another aspect, there is provided a dosage unit dispensing system comprising the dosage unit dispenser cap and the vial configured to mate with the housing forming the internal storage cavity, wherein the internal storage cavity is loaded with an effective amount of the dosage unit to complete a prescribed regimen.

The dosage unit dispensing system may comprise a dispenser key device configured to communicate with the dosage unit dispenser cap to unlock the cap from the vial or to enable the cap to be unlocked from the vial.

The dosage unit dispensing system may further comprise a computing network or a computing device in communication with the computer processor, the computing network or computing device configured to transmit the authorized instruction including the predetermined schedule to the communication element.

In some embodiments, the communication element may be configured to transmit data including one or more of the biological data, behavioral data, medication treatment progress data, and the authorized instruction to the computing network or computing device.

In some embodiments, the computing network or computing device is capable of revising the authorized instruction responsive to the data.

In some embodiments, the computing network or computing device is in communication with a plurality of dosage unit dispenser caps, and capable of revising the authorized instruction for each dosage unit dispenser cap responsive to the data received from the plurality of dosage unit dispenser caps.

In some embodiments, the computing network or computing device is configured to access a dispensing system platform.

In some embodiments, the dispensing system platform includes a patient module having a patient portal configured for user access.

In some embodiments, the patient portal is configured to provide the user with information from one or more dosage unit dispenser caps.

In some embodiments, the dispensing system platform includes an administrator module having an administrator portal configured for administrator access, wherein the administrator is a health provider selected from a pharmacist, a prescriber, a medical professional, a medical insurance professional, and a caretaker.

In some embodiments, the administrator portal is configured to provide the administrator with information from one or more dosage unit dispenser caps, wherein the one or more dosage unit dispenser caps are assigned to the same user or a plurality of users.

In some embodiments, the administrator module is configured to communicate with a central database accessible by a third party module.

In some embodiments, the administrator module is configured to transmit one or more of the biological data, the authorized instruction, behavioral data, and medication treatment progress data to the central database.

In accordance with another aspect, there is provided a method of facilitating distribution of a dosage unit. The method may comprise providing the dosage unit dispenser cap. The method may comprise providing instructions to mate the housing with the vial to form the internal storage cavity, wherein the internal storage cavity is loaded with an effective amount of the dosage unit to complete a prescribed regimen.

In some embodiments, the method may comprise filling the vial with the effective amount of the dosage unit and mating the vial with the housing to form the internal storage cavity.

In some embodiments, the method may further comprise locking the vial to the housing.

In some embodiments, the method may further comprise providing instructions to transmit the authorized instruction including the predetermined schedule to the communication element.

In some embodiments, the method may comprise providing the instructions to transmit the authorized instruction through an administrator portal on a dispensing system platform accessed on a computing network or computing device in communication with the computer processor.

In some embodiments, the method may further comprise receiving data including one or more of the biological data, behavioral data, medication treatment progress data, and the authorized instruction through the administrator portal.

In some embodiments, the method may further comprise revising the authorized instruction responsive to the data.

In some embodiments, the computing network or computing device is capable of revising the authorized instruction responsive to the data.

In accordance with another aspect, there is provided a pill dispenser cap comprising a housing defining an open-ended cavity configured to mate with a vial forming an internal storage cavity loaded with an effective amount of pills to complete a prescribed regimen; a biometric sensing module supported by the housing comprising at least one biometric sensor configured to collect biological data of a user including identity verification data; a dispensing port on the housing configured to dispense a predetermined number of the pills from the internal storage cavity, the dispensing port locked by a locking element and configured to be enabled to dispense the pills by the user responsive to activation of the biometric sensor verification of the identity of the user and on a predetermined schedule; and a computer processor supported by the housing in communication with the biometric sensing module, a memory that stores the biological data of the user, and a communication element that receives authorized instruction including the predetermined schedule and the predetermined number of pills.

In some embodiments, the biometric sensing module comprises at least one biometric sensor configured to collect the biological data of the user including health data.

In some embodiments, the pill dispenser cap further comprises a dispensing mechanism in communication with the computer processor configured to selectively direct the predetermined number of pills to the dispensing port.

In some embodiments, the dispensing mechanism is dimensioned to correspond with one or more selected pill sizes.

In some embodiments, the one or more selected pill sizes are selected from 5 to 000.

In some embodiments, the dispensing mechanism is removable from the pill dispenser cap and interchangeable with another dispensing mechanism.

In some embodiments, the dispensing mechanism is configured to selectively direct one pill to the dispensing port.

In some embodiments, the dispensing mechanism comprises an adapter configured to selectively direct the predetermined number of pills to a stage car in communication with the dispensing port.

In some embodiments, the dispensing mechanism is operatively connected to a motor programmed to rotate the dispensing mechanism delivering the predetermined number of pills to the dispensing port.

In some embodiments, the pill dispenser cap further comprises a rotational sensor in communication with the computer processor and configured to determine clocking of the dispensing mechanism.

In some embodiments, the pill dispenser cap further comprises a rechargeable power source supported by the housing operatively connected to the motor.

In some embodiments, the pill dispenser cap further comprises a load sensor in communication with the computer processor and configured to determine if the dispensing mechanism has loaded the predetermined number of pills.

### BRIEF DESCRIPTION OF THE DRAWINGS

FIG. 1 illustrates a pill dispensing system including a pill dispenser, a dispenser key, and a dispensing system platform, according to an embodiment.

FIG. 2 illustrates the pill dispenser according to the embodiment of FIG. 1.

FIG. 3 schematically illustrates a memory, a communication element, and a processor of a pill dispenser, according to an embodiment.

FIG. 4 illustrates the dispenser key device according to the embodiment of FIG. 1.

FIG. 5 schematically illustrates a processor, a memory, and a communication element, according to an embodiment.

FIG. 6 illustrates a portion of a pill dispenser, according to an embodiment.

FIG. 7 schematically illustrates a dispensing system platform, according to an embodiment.

FIG. 8 illustrates an example diagram of a possible data processing environment in which illustrative embodiments may be implemented.

FIG. 9 illustrates internal and external components of the device computer 152 and the server computer, according to an embodiment.

FIGS. 10-16 illustrate some examples of displays or pages of a patient module, according to one embodiment.

FIGS. 17-19 illustrate some examples of displays or pages of a doctor module, according to one embodiment.

FIG. 20 is a flow chart showing prescription flow via the pill dispensing system, according to an embodiment.

FIG. 21 illustrates the pill dispenser, according to one embodiment.

FIGS. 22A-22I illustrate several views of a dispensing system, according to an embodiment.

FIGS. 23A-23I illustrate several views of a dispenser cap, according to one embodiment.

FIGS. 24A-24D illustrate a top view of several conformations of a dispenser cap, according to one embodiment.

FIGS. 25A-25B illustrate exploded views of a dispenser cap, according to one embodiment.

FIGS. 26A-26D illustrate several perspective views of a dispenser cap, according to one embodiment.

FIGS. 27-28 illustrate some examples of displays or pages of an administrator module, according to one embodiment.

FIG. 29 is a schematic drawing of a system for patient treatment and monitoring, according to one embodiment.

FIG. 30 is a schematic drawing of an alternate system for patient treatment and monitoring, according to one embodiment.

### DETAILED DESCRIPTION

A variety of pill dispensers exist to dispense medicine in the form of pills, capsules, tablets, and others (all herein referred to as “pills”). Many have mechanisms that make it difficult for infants, toddlers, and small children to access the potentially dangerous medicine inside. Other pill dispensers have schedules to help individuals stay on schedule taking the medicine. Still other pill dispensers attempt to prevent access by keeping the dispenser locked until it is deemed to be time to ingest the medicine, at which time the dispenser unlocks, allowing an individual access to the medicine. None of these pill dispensers prevents unfettered access to the stash of pills inside the pill dispenser, which can be dangerous and problematic with patients or individuals who are addicted to the medicine being administered, who might have cognitive degeneration or impairment such that they forget their dosage, or who might have other unscrupulous motives to access the stash of medicine.

Additional conventional secure pill dispensers are locked and automatically dispense medicine at times deemed to be appropriate for ingesting the medicine. These pill dispensers can be broken, unlocked, or stolen, and the medicine inside accessed in bulk, and/or by individuals not intended to receive the medicine, unbeknownst to authorities or medical professionals.

A “smart”, secure pill dispenser and pill dispensing system can record and report patient behavior as it relates to administration of medicine outside the direct care of a doctor, in order to reduce or prevent medicine abuse, over-use, under-use, and misuse, and to facilitate proper medicine administration to a patient outside the direct supervision of a doctor.

In an embodiment, a pill dispensing system includes a pill dispenser, which includes a body, a dispensing port in the body to dispense medicine from the body, and a computer processor supported by the body.

In an embodiment, a pill dispensing system includes a dispensing system platform and a pill dispenser configured to communicate with the dispensing system platform. The dispensing system platform includes an administrator module having a central database and an administrator portal configured for system administrator access.

In an embodiment, a computer system for dispensing prescription medication comprises a plurality of computers, each computer of the plurality of computers comprising at least one processor, one or more memories, one or more computer readable storage media having program instructions executable by the computer to perform the program instructions comprising: prompting, by a first of the plurality of computers, an input of an electronic prescription order and a treatment instruction; sending, by the first of the plurality of computers, the prescription order and the treatment instruction to a second computer of the plurality of computers; correlating and recording, by the second of the plurality of computers, a pill dispenser identifier and prescription information; and prompting, by a third computer of the plurality of computers, activation of the pill dispenser.

In an embodiment, a pill dispenser key device includes a body housing a processor, a memory, and a communication element, the processor, the memory, and the communication element configured to communicate a digital key to a pill dispenser.

Devices disclosed herein may be used in a system for patient treatment and monitoring. The system may include a dispensing device connectable to a central database, also referred to as a “cloud-based database” and a dispensing system platform. The cloud-based database may store patient data, including historical patient data and optionally global patient data. The data stored on the cloud-based database may be accessible through the dispensing system platform running on a computing device. The dispensing system platform may include a plurality of modules, such as a patient module, a doctor module, and administrator module, and a third party module. Through the plurality of modules, the patient, doctor, and/or pharmacist may review the collected data and provide control instructions to the dispensing device. Each module may provide tailored functionality. In some embodiments, the dispensing system platform may be programmed to recognize trends from the data stored on the cloud-based database. The dispensing system platform may be programmed to make recommendations, for example, to recommend a treatment plan, based on the data stored on the cloud-based database.

The system for patient treatment and monitoring may be used to collect and store medical information. This system may be implemented to design personalized treatment plans, including optimizing combination therapies and cataloguing adverse combination outcomes, and enable real time data sharing between stakeholders. Thus, in addition to patient treatment plans, the systems described herein may be used for drug development and clinical trials, regulatory approval, supply chain optimization, and to collect and organize population public health data.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Disclosed is a tamper-resistant pill dispensing system which can be integrated with business to business electronic medical records (“EMR”) or electronic health records (“EHR”), for use by patients, physicians, insurance companies, pharmaceutical companies, and government agencies. The system aims to reduce prescription drug abuse, patient non-adherence, overdose, under-dose, prescription drug trafficking, and their related effects. The system can interfere with, or break, the cycle that leads to prescription drug abuse and can prevent the development of addiction tendencies in patients by consistently providing only doctor approved dosage amounts to a specific patient. For instance, in some embodiments the system may be designed to operate in accordance with a predetermined treatment plan provided by a doctor or authorized personnel which is unalterable by the user.

While prescription drug use is described generally, the devices and systems may be used with any medication (prescription or over the counter) or health supplement. The pill-dispensing system can be used whenever patients are prescribed or provided with controlled substances (e.g., Schedule II drugs such as opioids, stimulants, anxiolytics, and antidepressants) or other substances where physician monitoring would be beneficial (e.g., treatment of chronic diseases, treatment of terminal illnesses, treatment of mental health issues, administration of specialized medications, administration of combination therapies, and administration of antibiotics, among others). Additionally, the pill dispensing system can be used for drug development, clinical trials, and regulatory approval.

The disclosure relates generally to a pill dispensing system. However, it should be understood that the systems and devices disclosed herein may be employed for use with any of a variety of dosage units. In certain embodiments, the dosage unit is a pill. In some embodiments, the dosage unit may be a pill, tablet, or capsule, such as a gel or other capsule. In some embodiments, the dosage unit may be in a chewable or edible form. In some embodiments, the dosage unit may be dissolvable, such as a tablet or powder dissolvable in liquid or a tablet or powder dissolvable upon ingestion. In some embodiments, the dosage unit may be in liquid form.

Yet other dosage unit forms may be employed. Various dosage unit forms are described in standard formulation treatises, e.g., Remington's Pharmaceutical Sciences by E. W. Martin. See also, for example, Aulton, M. and Taylor, K., Aulton's Pharmaceutics: The Design and Manufacture of Medicines, 5^{th} Edition, 2017; Antoine, A., Gupta M. R., and Stagner, W. C., Integrated Pharmaceutics: Applied Preformulation, Product Design, and Regulatory Science, 2013. Thus, the systems and devices disclosed herein may be designed or fitted for use with one or more dosage unit selected from a pill, tablet, capsule, chewable or edible, dissolvable, liquid, or other dosage form.

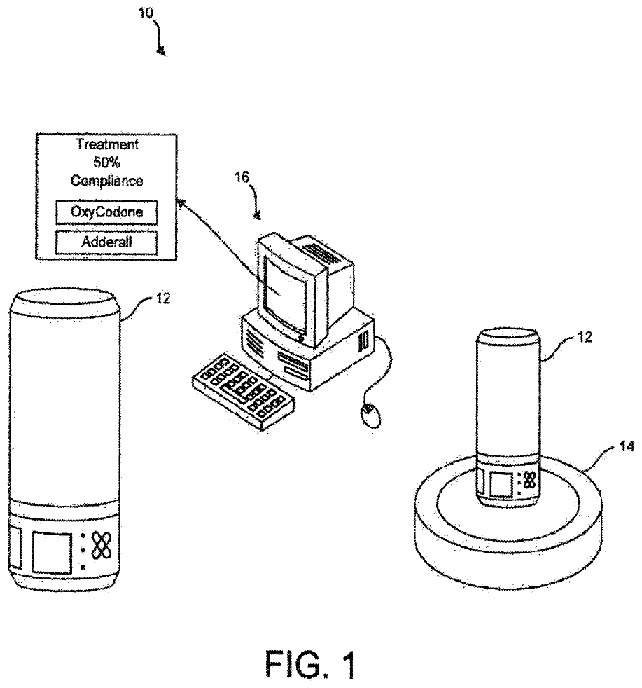

FIG. 1 illustrates a pill dispensing system 10, including a pill dispenser 12, a dispenser key 14, and a dispensing system platform 16, according to an embodiment. The pill dispenser 12 can be filled with medicine by a pharmacist, at the direction of a patient's doctor. The dispenser key 14 can be used to lock and unlock the pill dispenser 12 in order to fill the dispenser 12 with medicine. Doctors, pharmacists, insurance company representatives, patients, or others can interact with the pill dispenser 12 directly, or indirectly by accessing the dispensing system platform 16 via various portals, including a doctor portal, a pharmacist portal, a patient portal, etc.

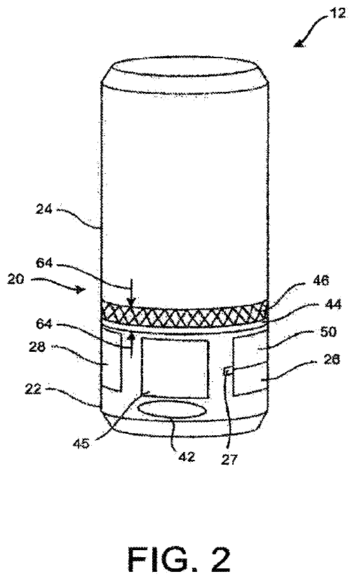

FIG. 2 illustrates the pill dispenser 12. The pill dispenser 12 has a body 20 including a cap 22 and a vial 24, and defining an internal pill storage cavity (not shown) connected to a dispensing port 26. The cap 22 may have a housing defining an open-ended cavity configured to mate with the vial 24 forming the internal pill storage cavity. The vial 24 can be sized and shaped to match standard sizes of prescription dram vials, which can facilitate automated processing of the pill dispensers 12. Thus, the cap 22 provided herein may be configured to mate with standard size prescription dram vials loaded with the pills to be dispensed. The cap 22 may be configured to lock with the vial 24, as described in more detail below.

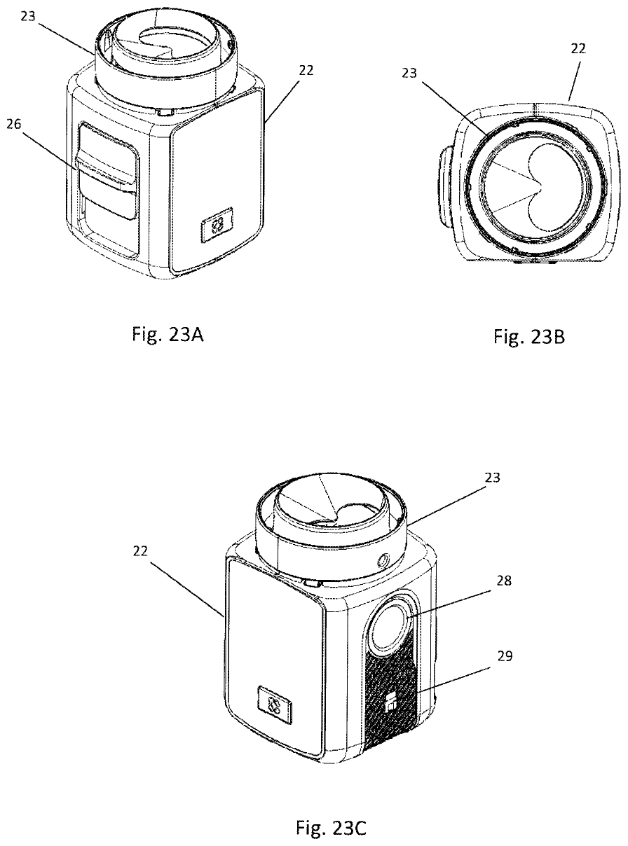

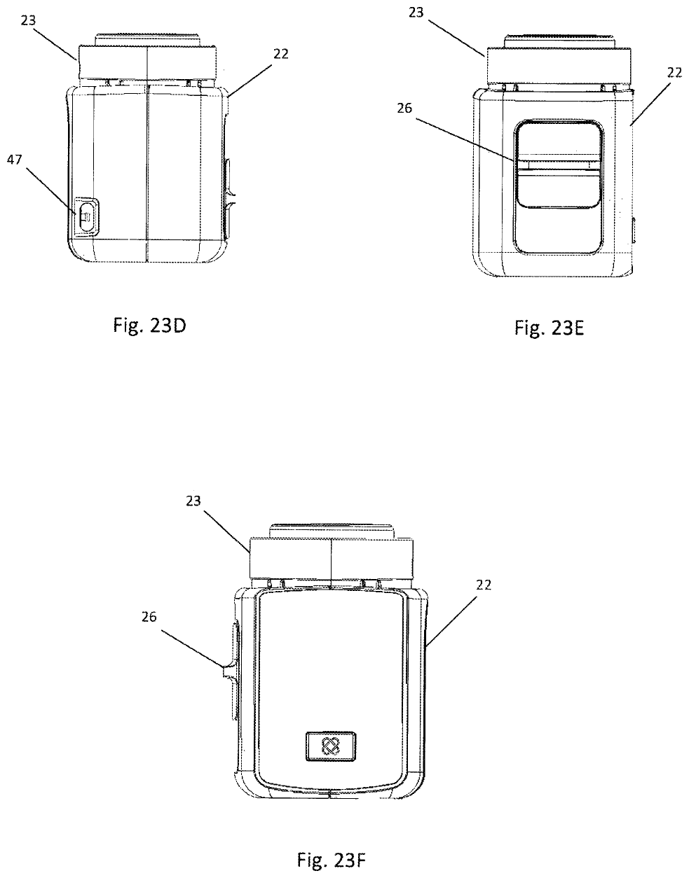

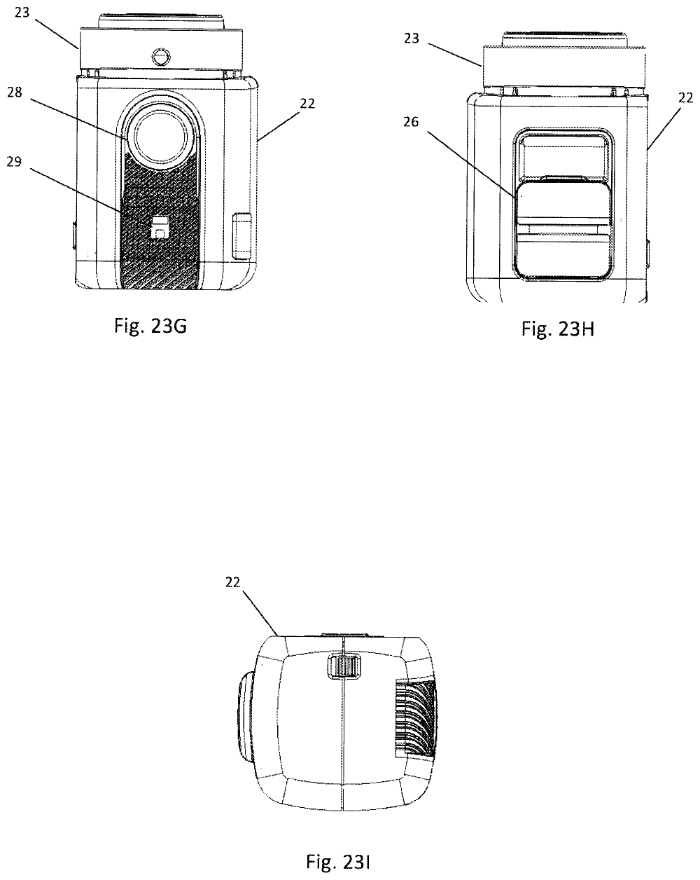

FIGS. 23A-23I illustrate several views of an exemplary dispensing cap 22. FIG. 23A shows a side perspective view of dispensing cap 22. FIG. 23B shows a top view of dispensing cap 22. FIG. 23C shows a side perspective view of dispensing cap 22 opposite the view of FIG. 23A. FIGS. 23D-23G each show an alternate side view of dispensing cap 22. FIG. 23H shows the same side view of dispensing cap 22 as FIG. 23E, however in FIG. 23H dispensing port 26 is toggled in an open position. In FIG. 23E dispensing port 26 is toggled in a closed position. FIG. 23I shows a bottom view of dispensing cap 22.

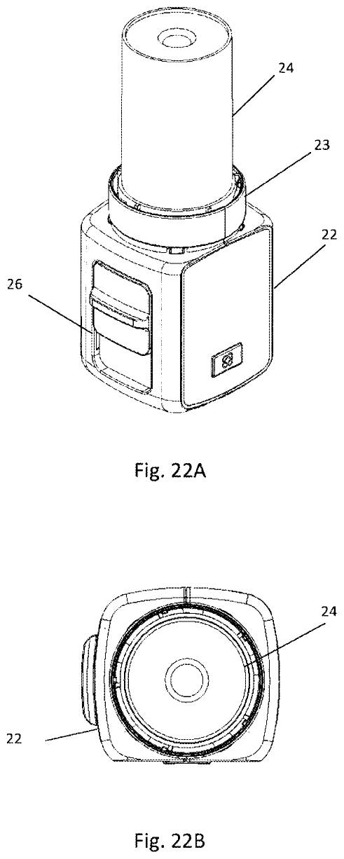

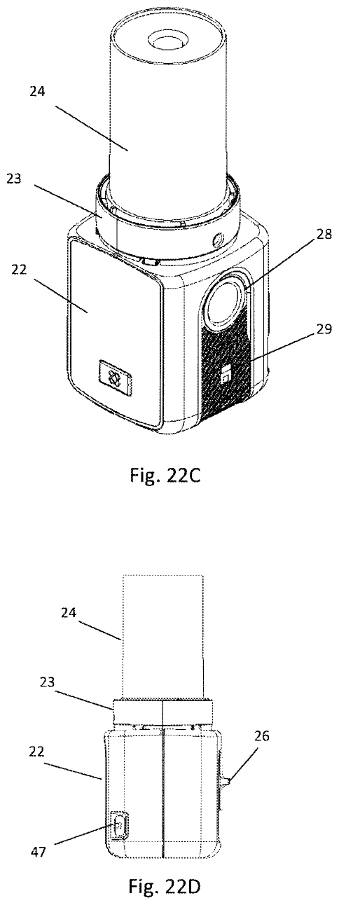

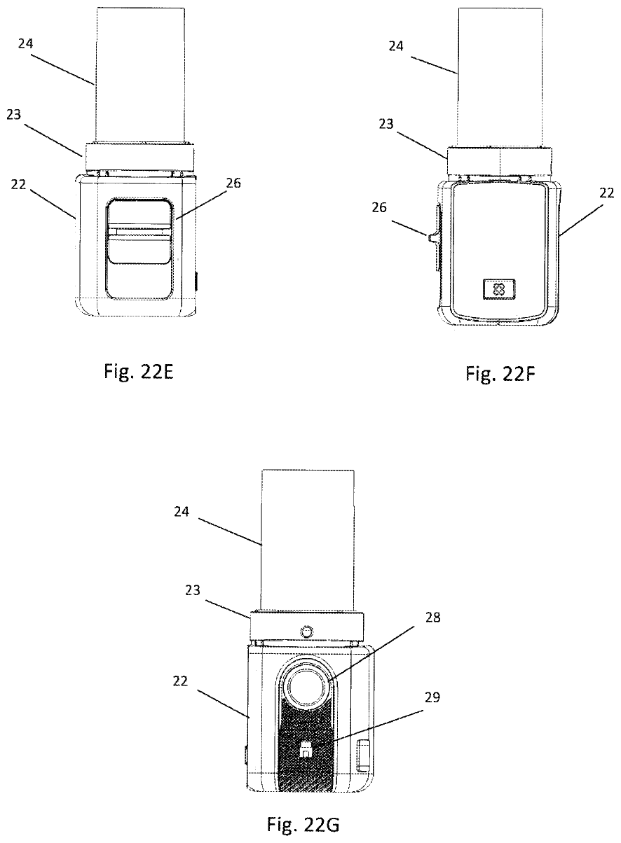

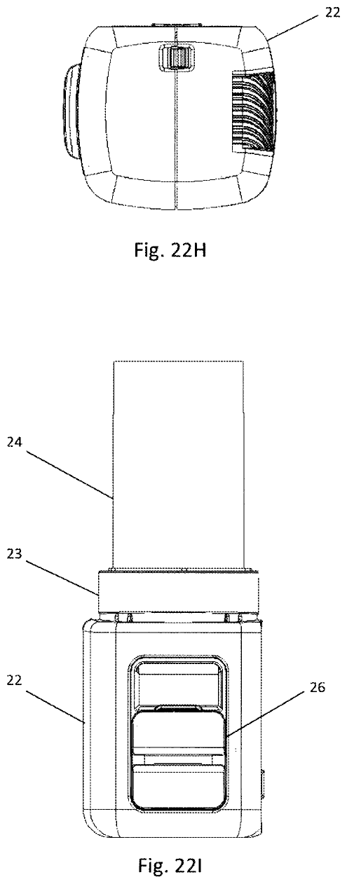

FIGS. 22A-22I illustrate several views of an exemplary dispensing system including dispensing cap 22 and vial 24. The views of FIGS. 22A-22I are similar to FIGS. 23A-23I, except that FIGS. 22A-22I show the dispensing cap 22 mated with vial 24.

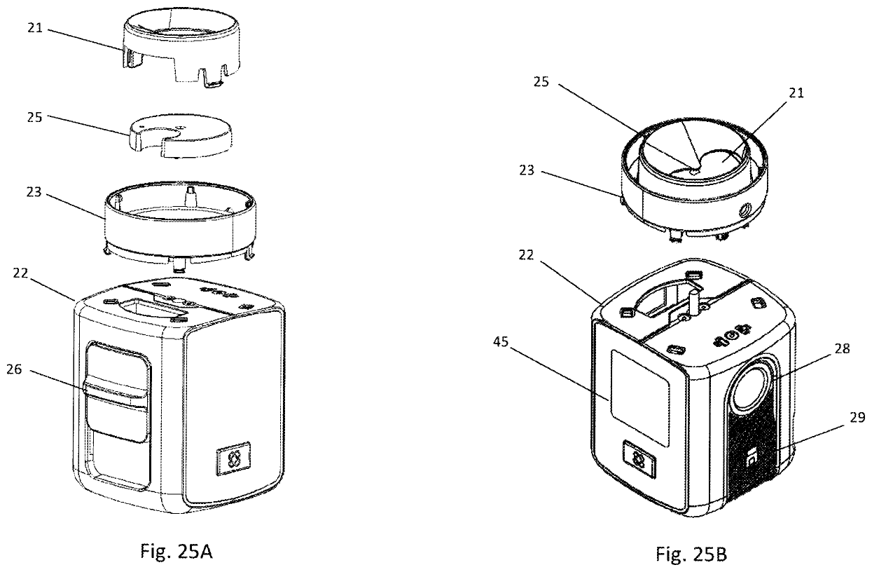

In some embodiments, the dispensing cap 22 may comprise a vial adapter 21 configured to mate different sized vials 24 with the cap 22. The vial adapter 21 may have a variable size opening (for example, may have an expandable opening) configurable to mate a selected size vial 24, such as one of a plurality of standard vial 24 sizes, with the cap 22. Exemplary standard vial sizes include 10, 20, 30, 40, 50, or 60 dram vials, each dimensioned for a selected pill size from 5 to 000. In some embodiments, a kit may be provided with a plurality of vial adapters 21, each vial adapter 21 dimensioned to mate one or more selected standard size vials 24 with the cap 22. The vial adapter 21 may be fitted between the vial 24 and dispensing mechanism 23, as shown in FIGS. 25A-25B. In particular, the vial adapter 21 may be fitted between the vial 24 opening and the dispensing mechanism 23 to form the internal pill storage cavity when fixed together. When connected, the vial 24 can define and bound a majority of the internal pill storage cavity, with the cap 22 configured to bound a minority of the internal pill storage cavity, or one side thereof.

The pill dispenser 12 is configured to dispense from the internal pill storage cavity a number of pills at the dispensing port 26, and/or an amount of medicine, prescribed by the patient's doctor. The pill dispenser 12 may comprise a dispensing mechanism 23 shown in FIGS. 25A-25B. In general, the dispensing port 26 and/or dispensing mechanism 23 may be structured to dispense medicine in one direction from the internal pill storage cavity to an exterior of the pill dispenser. For example, the dispensing mechanism may comprise an auger or stage car positioned to prevent access to the internal pill storage cavity when dispensing. Thus, the dispensing port 26 and/or dispensing mechanism 23 may be constructed and arranged to prevent pills or foreign objects from being introduced into the internal pill storage cavity. FIG. 25A is a first expanded view of the pill dispenser 12 showing the dispensing mechanism 23, adapter 21, and stage car 25 in an expanded conformation. FIG. 25B is a second expanded view of the pill dispenser 12 showing the adapter 21 and stage car 25 collapsed into the dispensing mechanism 23.

The dispensing mechanism 23 may be configured to selectively direct the predetermined number of pills to the dispensing port 26. As shown in FIGS. 25A-25B, the adapter 21 is configured to selectively direct the predetermined number of pills from the internal cavity (not shown in FIGS. 25A-25B for clarity) to the stage car 25. Stage car 25 is in communication with the dispensing port 26 through an opening on the upper surface of dispensing cap 22. The dispensing mechanism 23 may be operatively connected to a motor (not shown) programmed to rotate the dispensing mechanism 23, delivering the predetermined number of pills to the dispensing port 26. In some embodiments, the predetermined number of pills directed to the dispensing port 26 is one. Thus, in some embodiments, the dispensing mechanism 23 is configured to selectively direct one pill to the dispensing port 26. In other embodiments, the predetermined number of pills is more than one and the dispensing mechanism 23 may be configured to direct more than one pill to the dispensing port 26. In yet other embodiments in which the predetermined number of pills is more than one, the dispensing mechanism 23 may be configured to direct one pill to the dispensing port 26 at a time. The dispensing mechanism 23 may direct successive pills to the dispensing port 26 until the predetermined number of pills are dispensed. The dispensing mechanism 23, for example, the adapter 21 and/or stage car 25, may be dimensioned to correspond with one or more selected pill sizes. Exemplary pill sizes range from 5 to 000. The dispensing mechanism 23 and components thereof may be dimensioned to correspond with one pill size, for example, 5, 4, 3, 2, 1, 0, 00, or 000. The dispensing mechanism 23 and components thereof may be dimensioned to correspond with a range of pill sizes, for example 5-4, 4-3, 3-2, 2-1, 1-0, 0-00, 00-000, 5-3, 4-2, 3-1, 2-0, 1-00, or 0-000. In some embodiments, the dispensing mechanism 23 and components thereof may be variable in size, for example, may have an expandable components, configurable to correspond with a selected pill size. In some embodiments, a kit may be provided with a plurality of dispensing mechanisms 23 or adapters or components of the dispensing mechanism, each mechanism, adapter, or component dimensioned to correspond with a selected pill size. The dispensing mechanism 23 may be removable from the dispenser cap 22 as shown in FIG. 25B. When the dispensing system 12 is in an unlocked configuration (i.e., when vial 24 is not mated with dispensing cap 22), the dispensing mechanism 23 may be removed from dispensing cap 22 by twisting, squeezing, or otherwise uncoupling fasteners on the dispensing mechanism 23 or cap 22. The dispensing mechanism 23 may be interchangeable with another dispensing mechanism 23, for example, a dispensing mechanism 23 dimensioned to correspond with another pill size. Thus, a distributor or pharmacist may select a corresponding dispensing mechanism 23 when filling a prescription for the user.

The dispenser 12 may further comprise a rotational sensor configured to determine a status of the dispensing mechanism 23. For instance, the rotational sensor may determine position or clocking of the dispensing mechanism 23. The dispenser 12 may further comprise a load sensor configured to determine if the dispensing mechanism 23 has loaded the predetermined number of pills. The rotational sensor and/or load sensor may be configured to determine if the dispensing mechanism 23 is blocked or otherwise non-operational.

In some embodiments, the dispenser 12 comprises a rechargeable power source. The rechargeable power source may be supported by the housing of the dispenser cap 22. The rechargeable power source may be charged through charging or connection port 47, shown in FIGS. 22D and 23D. The rechargeable power source may be operatively connected to the display screen 45. The rechargeable power source 47 may be operatively connected to the motor. In some embodiments, the rechargeable power source may utilize wireless charging. The system may include a wireless charger. In other embodiments, the rechargeable power source may utilize standard charging cords, such as a USB-A, USB-C, microUSB, or other charging cord. The system may include a charging cord. In some embodiments, the rechargeable power source may be charged by solar and/or visible light source. Thus, in some embodiments, the device may include a solar and/or visible light panel. The panel may be positioned on one or more side of the device. In certain embodiments, the panel may be positioned surrounding the display screen. In some embodiments, the device may comprise a reserve power source in addition to the rechargeable power source. The pill dispensing device may emit a sound or other indicator, such as a light indicator or tactile indicator, when the power source is low on battery, for example, below 20%, below 10%, below 5%, or below 3% charge.

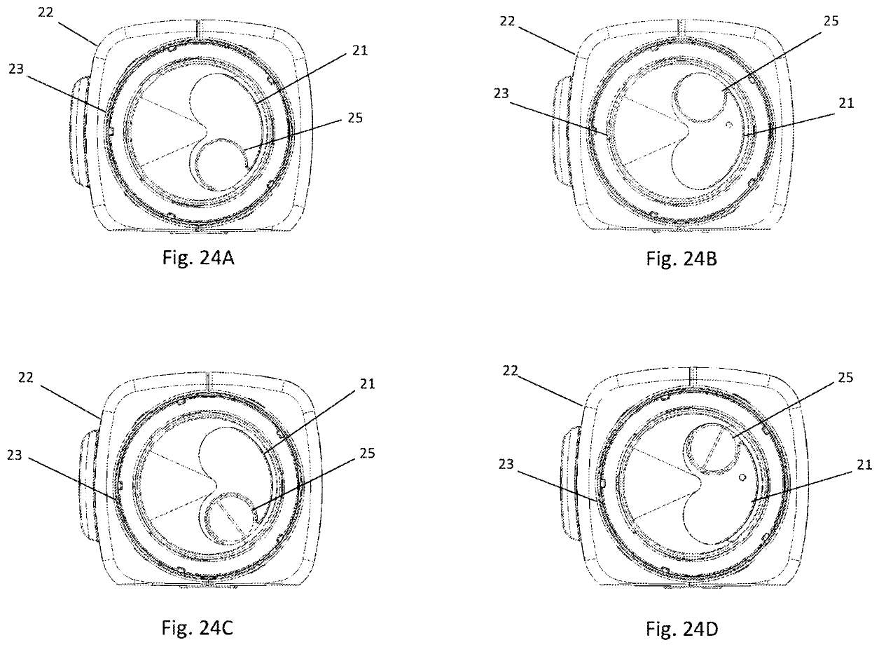

FIGS. 24A-24D illustrate several top views of an exemplary dispensing cap 22 including dispensing mechanism 23. Each of the embodiments shown in FIGS. 24A-24D include adapter 21 and stage car 25. However, each of the embodiments shown in FIGS. 24A-24D illustrate a different conformation of adapter 21 and stage car 25 in the rotation to dispense the predetermined number of pills.

The pill dispenser 12 may be in communication with secure access features, such as a biometric sensing module. The biometric sensing module, as shown in FIG. 1, may include a biometric identifier 28 supported by the housing of the cap 22. Additionally or alternatively, the biometric sensing module may include a biometric identifier or other sensor which is remote from the dispenser 12, for example, positioned on a wearable or mobile device. Thus, in some embodiments, the system may comprise a wearable biometric sensing device operatively connectable to the pill dispenser 12 or the system may operate in conjunction with a mobile device operatively connectable to the pill dispenser 12. It should be understood that any devices disclosed herein may be directly connectable to the pill dispenser 12 or connectable to the pill dispenser 12 via a common cloud application, also referred to herein as the dispensing system platform. The biometric sensing module may have at least one biometric identifier 28 or other sensor configured to collect biological data of a user including identity verification data and health data.

In exemplary embodiments, the biometric identifier 28 can include one or more of: a fingerprint sensor; voice recognition; a retinal scanner; facial recognition; or other now-known or future-developed identification means. The dispensing port 26 remains closed and locked by a locking element 27 until a time (or range of times) at which the pill dispenser 12 has been programmed to allow a patient to unlock and open the dispensing port 26 and dispense medicine. At this time, the patient can validate his or her identity by activating the biometric identifier 28.

In exemplary embodiments, the biometric identifier 28 can also collect biological data of the patient, such as, but not limited to, heart rate or irregular rhythm, cardiac electrical signals, skin temperature, body temperature, skin conductance, sweat rate, breath particulates, oxygen saturation, and voice characteristics.

The dispenser 12 may have one biometric sensor configured to collect the biological data of the user, including identity verification data and health data. The dispenser 12 may have at least two biometric sensors configured to collect the biological data of the user. Exemplary FIGS. 22C and 22G show a first biometric sensor 28 and a second biometric sensor 29. In FIGS. 22C and 22G, the biometric sensors 28 and 29 are supported by the housing of the dispenser cap 22.

However, the biometric sensing module may be in communication with one or more remote biometric sensors configured to collect biological data.

In some embodiments, as shown in FIGS. 22C and 22G, the two or more biometric sensors 28, 29 may be positioned on a same side of the cap 22. In other embodiments, the two or more biometric sensors may be positioned on different sides of the dispenser cap. One or both of the biometric sensors 28, 29 may be positioned opposite the dispensing port 26. One or both of the biometric sensors 28, 29 may be positioned on a same side as the dispensing port 26. One or both of the biometric sensors 28, 29 may be positioned opposite the display screen 45. One or both of the biometric sensors 28, 29 may be positioned on a same side as the display screen 45. In certain exemplary embodiments, two or more biometric sensors (e.g., 28, 29) may be positioned on a same side of the cap 22. The biometric sensors may be positioned in proximity to each other, for example, within a perimeter of a finger placed on the side of the cap 22. Thus, the biometric sensors may be used substantially simultaneously with one motion by the patient. Two exemplary biometric sensors that may be positioned in proximity to each other are a fingerprint sensor and a pulse oximeter. Each of the fingerprint sensor and the pulse oximeter may independently have a circular, triangular, rectangular, or other polygonal cross-sectional area. Each of the fingerprint sensor and the pulse oximeter may independently have a representative dimension of 2.5 cm or less, for example, 2 cm or less, 1 cm or less, 0.5 cm or less, 0.25 cm or less, or 0.1 cm or less. The dispenser cap 22 may include a finger sleeve. The finger sleeve may be positioned over any finger touch sensors. The finger sleeve may be beneficial for use with patients that have mobility limitations, such as tremors, to assist with usage of the finger touch sensors. In some embodiments, the finger sleeve may be removable. In other embodiments, the finger sleeve may be fixed. The finger sleeve may be formed of a polymer material. The finger sleeve may be sufficiently rigid to hold a finger in place over the finger touch sensors. However, the finger sleeve may be sufficiently flexible to accommodate fingers of different dimensions. Thus, the finger sleeve may be formed of a flexible or semi-flexible polymer or mesh material.

The biometric sensor may be one or more of a touch-activated biometric sensor, a sound-activated biometric sensor, a visual biometric sensor, and a breath particulate biometric sensor. A touch-activated biometric sensor may be capable of sensing one or more of: fingerprint, heart rate, blood oxygen saturation, breathing rate, temperature (e.g., skin temperature, body temperature), blood glucose level, skin capacitance, and viral or respiratory infection or a symptom thereof. Exemplary biometric sensors include finger scanners, pulse oximeters, heart rate monitors (e.g., optical and electrical), thermometers, blood glucose meters, and others. A sound-activated biometric sensor may be capable of sensing one or more of: voice and breathing pattern. Exemplary sound-activated biometric sensors include microphones, ultrasound scanners, and others. A visual biometric sensor may be capable of sensing one or more of ocular, facial, or other features, and temperature. Exemplary visual biometric sensors include cameras and infrared scanners, such as infrared thermometers and infrared lasers. A breath particulate biometric sensor may be capable of sensing one or more of: blood alcohol content (BAC), tetrahydrocannabinol (THC) content, blood glucose level, and viral or other pathogenic load.

In some embodiments, the system may collect biological data through a wearable device, mobile device, or other database used by the patient. For instance, a cloud application used in combination with a wearable device or health feature of the mobile device may be in communication with the pill dispenser or the dispensing system platform. Exemplary wearable devices include heart rate monitors (optical and electrical), gyroscopes or step counters, and temperature or skin conductance sensors, such as those typically found on smart watches or digital fitness trackers. Other databases, such as health applications and fitness tracking application may also be used to collect biological data. The dispensing system database may be programmed to communication with such health and fitness applications to collect additional biological data of the patient.

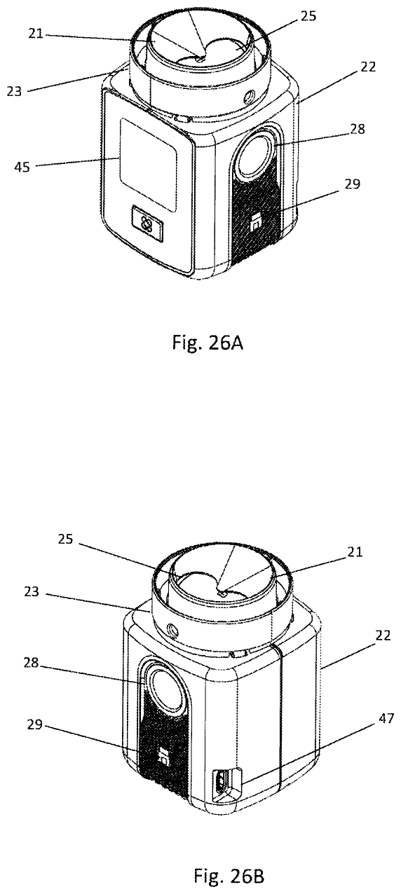

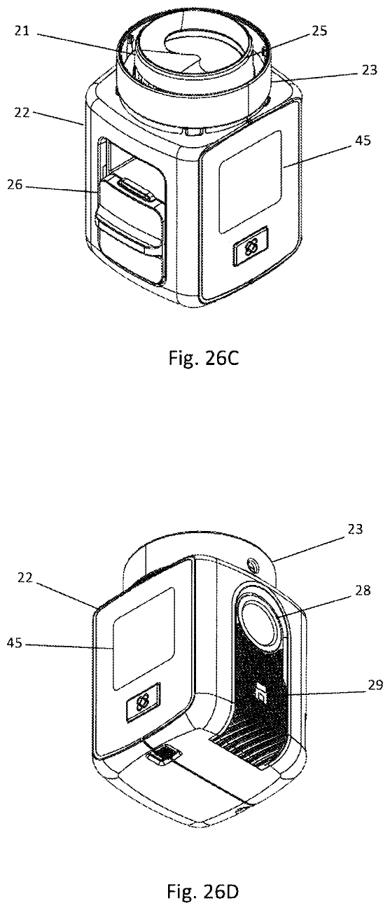

FIGS. 26A-26D illustrate several perspective views of an exemplary dispenser cap 22. As shown in FIGS. 26A-26D, a front side of dispenser cap 22 supports the display screen 45. A first lateral side of dispenser cap 22 supports biometric sensors 28, 29. A second lateral side of dispenser cap 22 opposite the first lateral side includes dispensing port 26. A back side of dispenser cap 22 opposite the front side includes charging or connection port 47. A top surface of dispenser cap 22 supports dispensing mechanism 23 including adapter 21 and stage car 25. The embodiments of FIGS. 26A-26D show one exemplary arrangement of the components of dispensing system 12. It should be understood that other arrangements of such components are within the scope of the disclosure. The dispenser 12 may include a computer processor 34 supported by the housing of dispenser cap 22. The computer processor may be in communication with a memory 30 and a communication element 32. The computer processor 34 may be operatively connected to one or more of dispensing port 26, dispensing mechanism 23 (and/or the motor of dispensing mechanism 23), display screen 45, biometric sensor 28, 29, indication element 46, and/or other components, such as rotational sensor, load sensor, limit switch sensor, and other sensors. The memory 30 may be a cloud-based storage connected to computer processor 34 via communication element 32. In other embodiments, the memory 30 may be a local memory device supported by the housing of dispenser cap 22.

The data collected by the biometric identifier 28 can be stored in a memory 30 and communicated to the dispensing system platform 16 via a communication element 32. This process, the locking and unlocking of the dispenser port 26, and further processes can be controlled by a processor 34. FIG. 3 schematically illustrates the memory 30, the communication element 32, and the processor 34. Each of the memory 30, the communication element 32, and the processor 34 can be housed on or within the cap 22. The communication element 32 may be configured to transmit data from the computer processor 34 to a computing network, computing device (including a mobile device), or cloud-based database. The communication element 32 can be used to transmit data by direct connection to the device or a shared network such as a cloud-based database, or wirelessly over cellular networks, local area network (LAN) or personal area network (PAN), such as via bluetooth® or Wi-Fi®, or other wireless networks. Direct connection to other devices or a computing device may be provided via charging or connection port 47.

In certain embodiments, the communication element 32 may be used to communicate with other pill dispensers 12, for example, other pill dispensers 12 assigned to the same user. Each of the electronically-driven functions of the pill dispenser 12 described herein can be controlled by instructions and rules configured on the processer 34 and/or the memory 30, by utilizing the communications element 32 to communicate with and receive instructions from a computing network or another computing device instantiating at least a portion of the dispensing system platform 16, or by a combination of both.

In certain embodiments, the communication element 32 may be used to communicate with a cloud-based database accessible via a cloud application, also referred to herein as a dispensing system platform. In some embodiments, the communication element 32 may be equipped to directly connect with the cloud-based database via a cellular network or provider network. For example, the communication element 32 may comprise a SIM card or modem connectable to a cellular network or provider network. In some embodiments, the communication element 32 may connect to the cloud-based database via a computing device. For instance, the communication element 32 may be equipped to connect to the computing device which is connectable to a cellular network or provider network. The communication element 32 may communicate with the computing device wirelessly over a LAN, PAN, or other wireless network, or via a wired connection through the charging or connection port 47.

In some embodiments, the communication element 32 may be equipped to connect to the cloud-based database via both a cellular network and a provider network. The dispensing device may be programmed to automatically connect to a preferred network, such as the provider network, when available. The dispensing device may be programmed to automatically connect to a backup network, such as a cellular network, upon losing connectivity through the preferred network. Thus, the device may ensure continuity of connectivity. In some embodiments, the communication element 32 may further be equipped to connect to the cellular network and/or provider network through a computing device.

The communication element 32 may be a two-way communication element between the processor 34 and the computing network, computing device, or cloud-based database. For instance, the communication element 32 may receive the authorized instruction from the dispensing system platform via the cloud-based database. The computer processor 34 may then notify the user of the authorized instruction, e.g., predetermined schedule and dosage for the medication. The communication element 32 may also be enabled to provide data, including one or more of biological data, behavioral data, and medication treatment progress data, to the cloud-based database, accessible by a user on the dispensing system platform. The communication element 32 may optionally provide the data to the cloud-based database via the computing network or computing device.

The dispensing system platform may be configured or programmed to notify the administrator to review the data and/or revise the authorized instruction responsive to the data. If a revision occurs, the computing network or computing device may push a notification to the user, optionally through the dispenser 12, to notify the user of a revision to the authorized instruction. The dispensing system platform may notify the user or administrator by electronic mail (e-mail), SMS text message, or push notification on a computing device running the dispensing system platform.

Referring again to FIG. 2, a voice interaction module can be included to provide patients with prescribed dosage information in accordance with the physician's instructions. The voice interaction module can be multilingual. The pill dispenser 12 can include a microphone 42 and a speaker 44, which can both be housed on or in the cap 22, and can both be used with the voice interaction module, as well as with a biometric identifier 28 if the biometric identifier utilizes voice identification. The voice interaction module can instruct patients how to properly take their medications, and can provide additional prescription treatment guidance by allowing patients to ask general questions (e.g., “When is my next dosage?”). The voice command can provide patients with the name of the medication, the dosage amount, and directed usage information (e.g., “take with plenty of water”, “take with a meal”, etc.). The voice command feature can be programmed using GPS location from the patient's mobile computing device (e.g., cell phone, tablet, laptop) to function only at specified locations, such as the patient's home. Outside the specified location, the feature can be programmed to remind patients through a sound mode or a vibrate mode to guarantee patient treatment privacy. The voice command, sound, and vibrate features can be programmed by patients to better accommodate to their personal needs.

The pill dispenser 12 may include an electronic display screen 45. A display screen 45, such as a touchscreen, can provide all the functionality of the voice interaction module, except in writing rather than sound. The display screen 45 can also be housed in or on the cap 22.

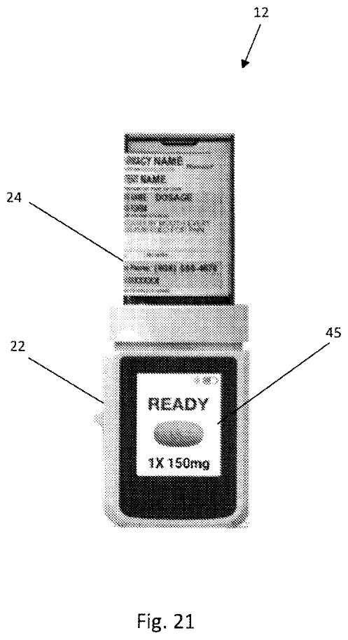

Referring to FIG. 21, the display screen 45 may be positioned on a front or lateral surface of the cap 22.

In some embodiments, the electronic display screen 45 is in communication with the computer processor. The display screen 45 may be configured to display at least a portion of the authorized instruction. As shown in FIG. 21, the display screen 45 may display information associated with the predetermined schedule (shown as a “READY” indication conveying that the dosage unit may be dispensed at this time in accordance with the predetermined schedule) and/or information associated with the predetermined dosage (shown as a “1×150 mg” indication conveying that the predetermined dosage is one 150 mg pill). The display screen 45 may alternatively show one or more indication, such as “NOT READY,” “OVERDUE,” “LATE,” or other time reference relating to the predetermined schedule. In some embodiments, the display screen 45 may display one or more of the current time, time until the next scheduled administration, and time elapsed from the last scheduled administration (as dispensed or overdue).

In some embodiments, the electronic display screen 45 is configured to display identification information for the dosage unit. As shown in FIG. 21, the identification information may include an image of the dosage unit. The identification information may additionally or alternatively include one or more of a name of the dosage unit (such as a chemical name, generic or nonproprietary name, trade name, and/or brand name), a description of the dosage unit (such as color, dosage unit type, and/or size), and a disease, condition, or symptom treatable by administration of the dosage unit (such as pain management or pain relief, fever reducer, infection, anxiety, depression, or others).

As shown in FIG. 21, the display screen 45 may also be configured to display battery life of the dispenser 12 or cap 22 and/or connectivity status of the communication element 32 (for example, Wi-Fi®, Bluetooth®, cellular network, provider network, or other connectivity bars, or not connected symbol). The display screen may display one or more result from the biometric sensor 28, 29 measurement.

The display screen 45 may additionally or alternatively be configured to display further instructions associated with the dosage unit. Exemplary further instructions include whether to take the dosage unit with food and/or water, take the dosage unit without food and/or water, take the dosage unit before or at the time of going to sleep, refrain from combining the dosage unit with any other medication, supplement, or foods, refrain from operative heavy machinery and/or driving a car upon taking the dosage unit, and others. The further instructions may be customizable by the administrator and optionally provided to the pill dispenser 12 as part of the authorized instruction. In some embodiments, the display screen 45 may operate as an input device for the computer processor. The dispensing system platform may be installed on the computer processor and accessible via the display screen 45. A user may scroll and/or toggle one or more menu to change device settings, request information from the cloud-based database or provide information to the cloud-based database. For instance, a prompt may appear on the display screen 45 to provide information related to symptoms, mental state, or recent food or water intake. In some embodiments, the dispensing port may be enabled to dispense the dosage unit responsive to positive feedback from the user. In some embodiments, an administrator may provide instructions to prompt the user to answer one or more questions. The administrator may revise the treatment plan responsive to the answers received from the user.

Referring back to FIG. 2, indication lights 46, which can be light emitting diodes (“LEDs”) or another light source, can illuminate a specified color at a time the patient is scheduled to take a dosage or within a predetermined window. The indication lights 46 can also be housed in or on the cap 22. While the indication lights 46 can be arranged variously, in the embodiment of FIG. 2 the indication lights are shown as a strip of light emitting diodes encircling an end of the cap 22. To better draw the patient's attention, the indication lights 46 can blink or flicker. The color that the indication lights 46 illuminate can match the color of medication listed in the dispensing system platform 16 in a color coded legend. For example, if a patient is scheduled to take oxycodone and the medication is color coded as blue on the software application, then the indication lights 46 can illuminate blue to indicate it is time to take the medicine. While lights 46 are shown in FIG. 2, it should be noted that the indication element may be one or more of a light, a speaker, a vibration element, or any other indication element supported by the housing and configured to notify a user at a time the patient is scheduled to take a dosage or within a predetermined window. The indication element may be configured to notify the user periodically until the dosage unit is dispensed. The indication element may be operatively connected to the computer processor and/or display screen. The user may be capable of selecting one or more setting relating to the indication element, for example, through an input device, such as a button or the display screen 45. For instance, the user may select whether the indication element will flash, make a sound, and/or vibrate. The user may select to shut off or dismiss (“snooze”) the indication element until a later time. The pill dispenser 12 can be configured with the ability to record patient conversation and behavioral data, and the ability to report this data to the patient's doctor, as well as to insurance companies or other specified individuals or entities via the cloud-based database. In this way, early intervention can be provided to prevent misuse, abuse, and addiction to Schedule II prescription medications. Tampering with the pill dispenser 12 can also be detected and reported. For instance, the pill dispenser may contain a limit switch sensor configured to detect tampering with one or more component of the dispenser. The limit switch sensor may be in communication with the computer processor, such that the dispensing system platform may be programmed to notify a user or other authorized individual of tampering responsive to receiving an indication from the computer processor. Data regarding the tampering event may be stored in a local memory or the cloud-based database. Furthermore, malfunction from the device may be detected and reported. The rotation sensor and/or load sensor may be in communication with the computer processor, such that the dispensing system platform may be programmed to notify a user or authorized individual of a malfunction of the device responsive to receiving an indication from the computer processor. In certain embodiments, in case of a malfunction that prevents automatic dispensing, an emergency, mechanical dispensing button 50 can unlock and activate the dispenser port 26. The dispensing button 50 can be configured to be depressed or otherwise locked, and pop out or otherwise become active for use only when the pill dispenser 12 sends a signal to the computer processor indicating the pill dispenser 12 is unable to dispense a dosage of medicine. Simultaneously, the indication lights 46 can illuminate and/or the speaker 44 can emit an audible indicator. In other embodiments, the device may be free of any mechanical dispensing button.

In certain embodiments, in the case of a pill jam in the pill dispenser 12 that would block further pills from being dispensed through the dispenser port 26, the cap 22 can unlock from the vial 24 so that the patient can disconnect the cap 22 from the vial 24. Pill jams may also be detected and reported as previously described. The emergency dispensing button 50 and/or the unlocking of the cap 22 from the vial 24 can be disabled for medicine for which failed administration is non-life threatening, and enabled for medications that are time sensitive, and for which failed administration can be life threatening. Activation of the emergency dispensing button 50 can bypass identity verification by the biometric identifier 28. The emergency dispensing button 50 can also be used as the main dispensing method for patients who are not able to use the biometric identifier 28, who are unable to self-administer medicine, and/or who require third party treatment assistance.

In certain embodiments, the pill dispenser 12 can be configured such that if a patient not authorized to use the emergency dispensing button 50 as the primary dispensing method uses the emergency dispensing button 50, the pill dispenser 50 and/or the dispensing system platform 16 can require the patient to provide a reason for using the emergency button 50 by selecting an option provided by the dispensing system platform 16. Any malfunction, pill jam, or other use of the emergency dispensing button 50 may be recorded in the local memory or cloud-based database and can be made available to both physicians and the patient's health insurance provider through the dispensing system platform for further action.

Besides through the dispensing port 26, the only access to the internal cavity (not shown) is by unlocking and removing the cap 22 from the vial 24. The cap 22 can be unlocked from the base 22 electronically by a digital key. The digital key may be provided to select medical professionals, such as pharmacists.

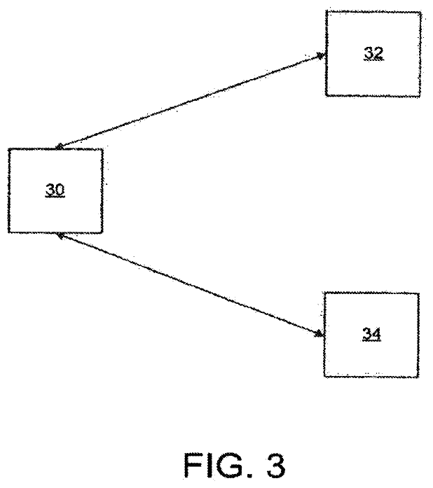

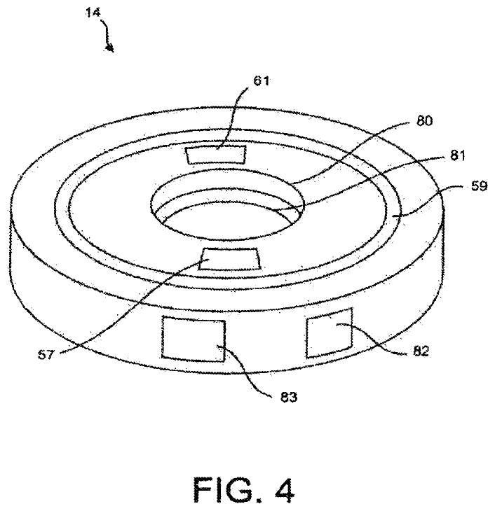

The digital key can be provided by the dispenser key device 14. FIG. 4 illustrates the dispenser key device 14, which can also include a processor 52, a memory 54, and a communication element 56, as illustrated in FIG. 5. The processor 52, memory 54, and communication element 56 provide capability for the dispenser key device 14 to process program instructions, store information, and communicate with a network or other computing device. Accordingly, the dispenser key device 14 can communicate with the pill dispenser 12 and the dispensing system platform 16. Referring to FIG. 4, the dispenser key device 14 can be configured to receive the pill dispenser 12, such as in receptacle 80, shaped congruently with the cap 22 to receive the cap 22. A single receptacle is shown in the illustrated dispenser key device 14, though any practical number of receptacles 80 can be included in a single dispenser key device 14. Similarly, the shape of the dispenser key device 14 is shown as that generally of a disc, which is not intended to be limiting.

A first scanner 81 can be located in the receptacle 80, positioned such that when the cap 22 is placed in the receptacle 80, the first scanner 81 can read a barcode or other type of code scannable or readable code located on the cap 22 automatically using a scanning device. For simplicity, herein, all types of scannable or readable codes (for example, QR codes) are referred to as barcodes herein. Any information associated with the barcode can be stored in the memory 54 and/or communicated to the pill dispenser 12, the dispensing system platform 16, another network used by the pharmacist, or other networks or computers. For example, information to identify and catalog the particular pill dispenser 12 can be collected by the dispenser key device 14 in this manner. Every cap 22 can be assigned a specific and unique alphanumeric code, for example, and any time the cap 22 is placed in the receptacle 80 of the dispenser key device 14, the dispenser key device 14 and the dispensing system platform 16 can know this unique code and precisely which pill dispenser 12 is in the dispenser key device 14.

The dispenser key device 14 can also include a second scanner 82 to read barcodes. The second scanner 82 can be configured to read the same types of barcodes that the first scanner 81 reads, or different types of barcodes. The second scanner 82 is positioned in a location relatively convenient for a pharmacist to scan a barcode affixed (e.g., by the pharmacist when filling a prescription) to a side of the pill dispenser 12. The barcode can correspond to information related to the patient and the prescription, such as but not limited to medicine type and quantity.

The information retrieved by the first scanner 81 or the second scanner 82 can be displayed a display 83. The display 83 can be any now-known or future-developed illuminating screen, such as a touchscreen, an LED, and OLED, etc. The display 83 can also display warnings, advertisements, or notices. The display 83 can display a notice that a new prescription has arrived, and/or display the prescription order, or any other information stored by or received by the dispenser key device 14.

The dispenser key device 14 can be configured such that the digital key, which can be a special code directing the pill dispenser 12 to lock or unlock, or to allow the cap 22 to be unlocked from the vial 24, can be communicated to the pill dispenser 12 as a result of the first scanner 81 reading the barcode on the top of the cap 22. In some embodiments, near field communication can be used to exchange the digital key. In these embodiments, for example, when the pill dispenser 12 is placed within close proximity (e.g., less than six inches) to the dispensing key device 14, the information is shared. In some embodiments, the digital key is not communicated between the pill dispenser 12 and the dispenser key device 14 until an unlocking element 57, such as an unlocking button on the dispenser key device 14 is activated. Referring to FIG. 4, the unlocking button 57 to unlock the pill dispenser 12, or key indicator lights 59, can illuminate one or more colors of light to indicate various statuses. A first color, such as green, can indicate information is ready to be shared between the pill dispenser 12 and the dispenser key device 14. A second color, such as blue, can indicate successful sharing of information between the pill dispenser 12 and the dispenser key device 14. A third color, such as red, can indicate unsuccessful sharing of information between the pill dispenser 12 and the dispenser key device 14.

The digital key can also have a biometric recorder 61, such as a fingerprint scanning pad, camera, microphone, or other biometric recorder 61, which can be used to record a biometric identifier of the patient, such as the patient's fingerprint, voice recognition, facial recognition, or retina scan. The saved biometric identifier can be correlated with unique code of the pill dispenser 12, and both can be transmitted to the pill dispenser 12 and/or the cloud-based database, and saved under a personal treatment chart of the patient on the dispensing system platform 16.

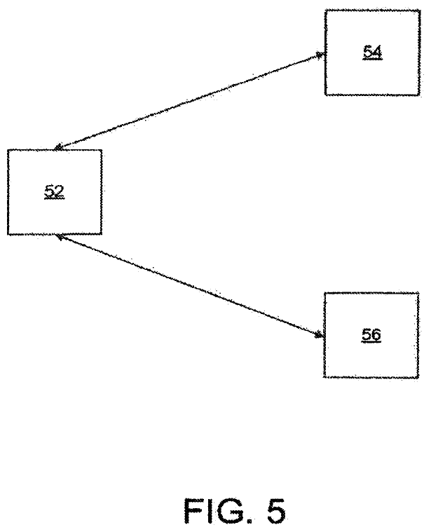

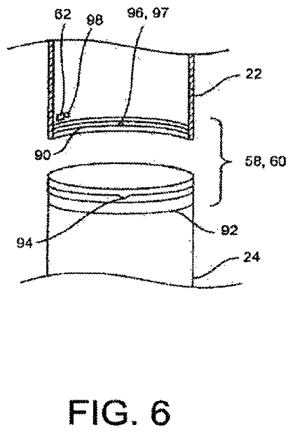

A two-step locking element restricts access to an internal pill storage cavity (not shown). FIG. 6 shows an example of a two-step locking 58 wherein the cap 22 has interior threads 90 and the vial 24 has exterior threads 92. The cap 22 is shown sectioned to reveal the interior threads 90. A primary locking element 60 of the two-step locking element 58 can activate upon connecting the cap 22 with respect to the vial 24. The cap 22 can twist onto the vial 24 in a conventional manner using threads on the cap 22 and the vial 24, or the cap 22 can connect to the vial 24 by other conventional means. The primary locking element 60 can engage before the cap 22 is fully connected. For example, with a twist-on cap, the primary locking element 60 can engage after twisting the cap 22 a predetermined portion leaving room for the cap 22 to be twisted further. The primary locking element 60 can retain the cap 22 on the vial 24, while allowing removal upon applying a threshold removal force, to allow a user to remove the cap manually without difficulty. A first sound or other indicator can designate when the primary locking element 60 is activated or deactivated, to alert the user (i.e., the pharmacist).

In the example shown in FIG. 6, the exterior threads 92 can have a protrusion 94 which can engage a depression 96 in the cap 24 among the interior threads 90. A sensor 98 at the depression 96 can detect engagement of the protrusion 94 with the depression 96, and can generate a signal to the processor 34. The protrusion 94 in the depression 96 can have enough friction to retain the cap 22 on the vial 24, while allowing a reasonable force to twist the cap 22 further on to the vial 24 or off the vial 24.

As a result of the cap 22 being twisted until the primary locking element 60 is activated, the pill dispenser 12 can emit a voice message via the speaker 44 and/or a color coded illumination via the indication lights 46. The voice message can provide a user (i.e., the pharmacist) with a warning message upon activation of the primary locking element 60. An example of a warning message can be, “Please verify or make sure that the prescription was filled properly prior to twisting the cap further to engage the secondary locking mechanism”. In this way, the primary locking element 60 can allow pharmacists to verify if the medication was filled in accordance to the prescription order, and to untwist the cap 22 to open the pill dispenser 12 in case any mistakes are made during the prescription filling process. Each pill dispenser 12 can be provided to the pharmacist with a placebo placed in the internal storage cavity (not shown) so the pharmacist can conveniently test the device.

A secondary locking element 62 of the two-step locking element 58 can be activated by twisting the cap 22 further. Amongst other variations, the secondary locking element 62 can be a mechanically activated lock with an electronic release. A sensor 99 can determine when the cap 22 is fully connected to the vial 24 to trigger engagement of the secondary locking element 62, and a second sound, voice message, or other indicator can designate when the secondary locking element 62 is activated or deactivated. The secondary locking element 62 can be activated when the cap 22 is twisted all the way onto the vial 24. Alignment indicators 64 (see FIG. 2) on the pill dispenser 12, such as, but not limited to arrows, lines, or grooves, can act as guides, or further indicators that the cap 22 is fully connected and secured on the vial 24.

A pharmacist can use the unlocking button 57 to unlock the pill dispenser 12 upon placement of the pill dispenser 12 on the center of the dispenser key device 14. If the pill dispenser 12 needs to be unlocked, the pharmacist can press the unlocking button 57 located on the dispenser key device 14. As a result of being pressed, the unlocking button 57 can illuminate one or more designated colors. When the unlocking button 57 illuminates, the pharmacist can place the desired pill dispenser 12 to be unlocked on the dispenser key device 14. Upon placement of the pill dispenser 12 and successful sending of an unlock signal from the dispenser key device 14, the unlocking button 57 stops illuminating and the key indicator lights 59 can illuminate a designated color, and then dim.

Lock/Unlock signals sent by the dispenser key device 14 to the pill dispenser 12 can constantly change to reduce or prevent hacking of digital keys.

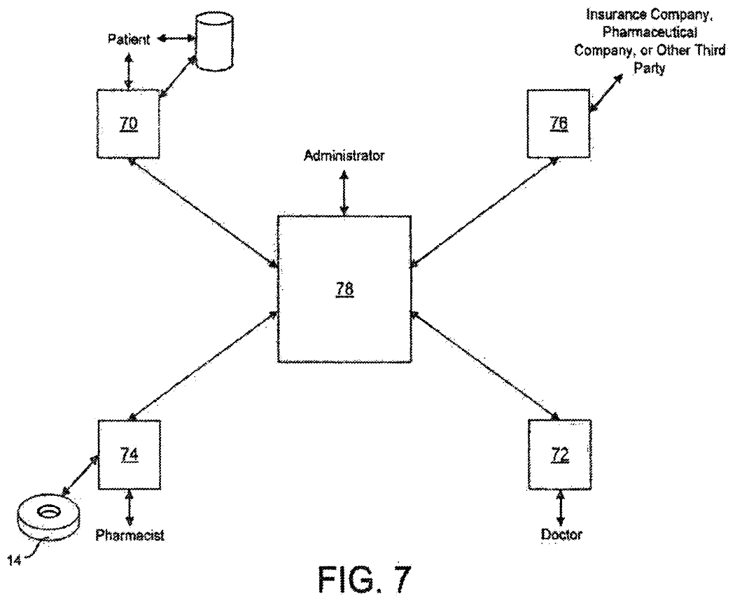

Referring to FIG. 7, doctors, pharmacists, insurance company representatives, patients, or others can interact with the pill dispenser 12 directly, or indirectly by accessing the dispensing system platform 16 via various modules of the dispensing system platform 16, including a patient module 70, a doctor module 72, a pharmacist module 74, and a third-party module 76. Each module 70, 72, 74, 76 can include a portal for direct interaction between the dispensing system platform 16 and a patient, doctor, pharmacist, or insurance company, respectively. Also, each module 70, 72, 74, 76 can communicate with an administrator module 78, which can include a portal for an administrator's access, and access to the cloud-based database of information received from each module 70, 72, 74, 76. The administrator module 78, the patient module 70, the doctor module 72, the pharmacist module 74, and the third-party module 76 can each be accessible on one or more computing networks or computing devices. In this way, the dispensing system platform 16 can be distributed over various computing devices connected to the cloud-based database over a network. The pill dispenser 12 can also be connected to the cloud-based database, directly via cellular network or provider network or indirectly via a computing network or computing device connected to a cellular network or provider network.

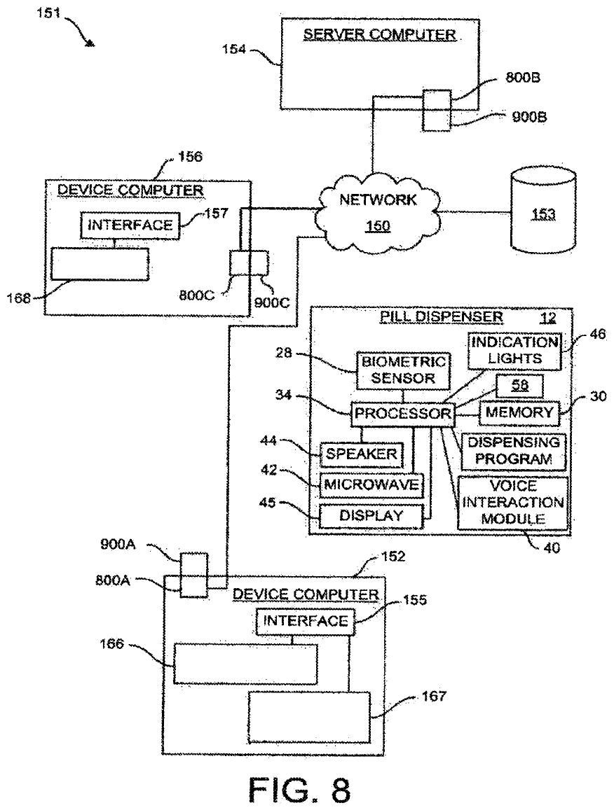

FIG. 8 illustrates an example diagram of a possible data processing environment in which illustrative embodiments may be implemented. It should be appreciated that FIG. 8 is only an example and is not intended to assert or imply any limitation with regard to the environments in which different embodiments may be implemented. Many modifications to the depicted environments may be made.

Referring to FIG. 8, network data processing system 151 is a network of computers in which illustrative embodiments may be implemented. Network data processing system 151 contains network 150, which is the medium used to provide communication links between various devices and computers connected together within network data processing system 151. Network 150 may include connections, such as wired connections, wireless communication links, or fiber optic cables.

In the depicted example, device computer 152, a repository 153, and a server computer 154 connect to network 150. In other example embodiments, network data processing system 151 may include additional client or device computers, storage devices or repositories, server computers, and other devices not shown. The network data processing system may also include the pill dispenser 12, which also is or includes a device computer.

The device computer 152 may contain an interface 155, which may accept commands and data entry from a user. The interface can be, for example, a command line interface, a graphical user interface (GUI), a natural user interface (NUI) or a touch user interface (TUI). The device computer 152 can, for example, access the patient module 70, the doctor module 72, the pharmacist module 74, or the third party module 76. While not shown, it may be desirable to have all or portions of the any one of the modules 70, 72, 74, 76 present on a server computer 154. The device computer 152 includes a set of internal components 800a and a set of external components 900a, further illustrated in FIG. 8.

While the dispensing system platform, including modules 70, 72, 74, and 76, may be in communication with a cloud-based database storing the information necessary to run the dispensing system platform, a server computer 154 may be provided to facilitate or back up the cloud-based database. Additionally, while the disclosure refers to a cloud-based database in general, it should be understood that the central database, or portions thereof, may be stored on a server. The exemplary server computer 154 includes a set of internal components 800b and a set of external components 900b illustrated in FIG. 8. In the depicted example, server computer 154 provides information, such as boot files, operating system images, and applications to the device computer 152. Server computer 154 can compute the information locally or extract the information from other computers on network 150.

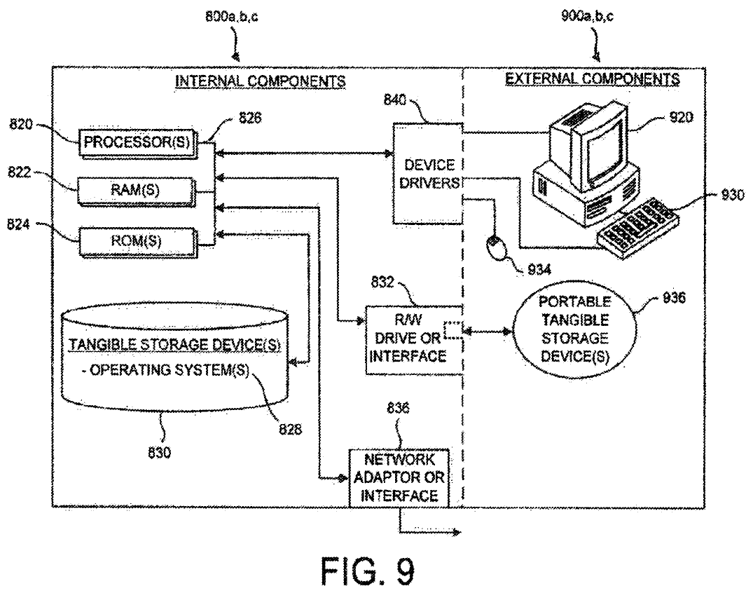

Program code and programs to implement the modules 70, 72, 74, 76, 78 may generally be stored on the cloud-based database. However, in certain embodiments, program code and programs may be stored on at least one of one or more computer-readable tangible storage devices 830 shown in FIG. 8, on at least one of one or more portable computer-readable tangible storage devices 936 as shown in FIG. 8, or on storage unit 153 connected to network 150, or may be downloaded to a device computer 152 or server computer 154, for use. For example, program code and programs such as for the modules 70, 72, 74, 76, 78 may be stored on at least one of one or more storage devices 830 (FIG. 9) on server computer 154 and downloaded to device computer 152 over network 150 for use. Alternatively, server computer 154 can be a web server, and the program code, and programs such as modules 70, 72, 74, 76, 78 may be stored on at least one of the one or more storage devices 830 on server computer 154 and accessed device computer 152. In other example embodiments, the program code, and programs such as for the modules 70, 72, 74, 76, 78 may be stored on at least one of one or more computer-readable storage devices 830 (FIG. 9) on device computer 152 or distributed between two or more servers.

In one example, network data processing system 151 is the Internet with network 150 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 151 also may be implemented as a number of different types of networks, such as, for example, an intranet, local area network (LAN), or a wide area network (WAN). FIG. 8 is intended as an example, and not as an architectural limitation, for the different illustrative embodiments. FIG. 9 illustrates internal and external components of the device computer 152 and the server computer 154 in which illustrative embodiments may be implemented. In FIG. 9, the device computer 152 and the server computer 154 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830.

In certain embodiments, the one or more operating systems 828 and programs to implement the modules 70, 72, 74, 76, 78 are stored on one or more of the computer-readable tangible storage devices 830 for execution by one or more of the processors 820 via one or more of the RAMs 822 (which typically include cache memory). In the embodiment illustrated in FIG. 9, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a RAY drive or interface 832 to read from and write to one or more portable computer-readable tangible storage devices 936 such as a CD-ROM, DVD, memory stick, magnetic tape, magnetic disk, optical disk or semiconductor storage device. Programs to implement the modules 70, 72, 74, 76, 78 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. The programs to implement the modules 70, 72, 74, 76, 78 can be downloaded to the device computer 152 and the server computer 154 from an external computer via a network (for example, the Internet, a local area network or other, wide area network) and network adapter or interface 836. From the network adapter or interface 836, programs to implement the modules 70, 72, 74, 76, 78 are loaded into hard drive 830. Programs to implement modules 70, 72, 74, 76, 78 can be downloaded to the server computer 154 from an external computer via a network (for example, the Internet, a local area network or other, wide area network) and network adapter or interface 836. From the network adapter or interface 836, programs to implement the modules 70, 72, 74, 76, 78 are loaded into hard drive 830. The network may comprise copper wires, optical fibers, wireless transmission, routers, firewalls, switches, gateway computers and/or edge servers.

In other embodiments, the programs to implement the modules 70, 72, 74, 76, 78 are accessible via the cellular network or provider network. Limited information from the dispensing system platform may be downloaded locally to the device computer 152 to facilitate use of the dispensing system platform. However, the majority of the program to implement the modules 70, 72, 74, 76, 78, and the majority of the data associated with the dispensing system platform, may be stored on the cloud-based database accessible via the cellular network or provider network.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824). In certain embodiments, the external components may comprise or consist of a display screen, for example, a touch screen.

Programs to implement the modules 70, 72, 74, 76, 78 can be written in various programming languages including low-level, high-level, object-oriented or non object-oriented languages. Alternatively, the functions of the modules 70, 72, 74, 76, 78 can be implemented in whole or in part by computer circuits and other hardware (not shown). Blockchain technology can be used with the dispensing system platform 16 for security purposes to prevent unauthorized access to patient treatment data, to protect the pill dispenser 12 and the dispensing system platform 16 from hacking. The blockchain technology can allow patients to be alerted of any inappropriate personal treatment health data access, and to have more control over their treatment regime as the patients will have the ability to select who and what level of personal health data can be made accessible by different authorized parties (i.e. primary care physician, specialists, family caregiver, etc.).

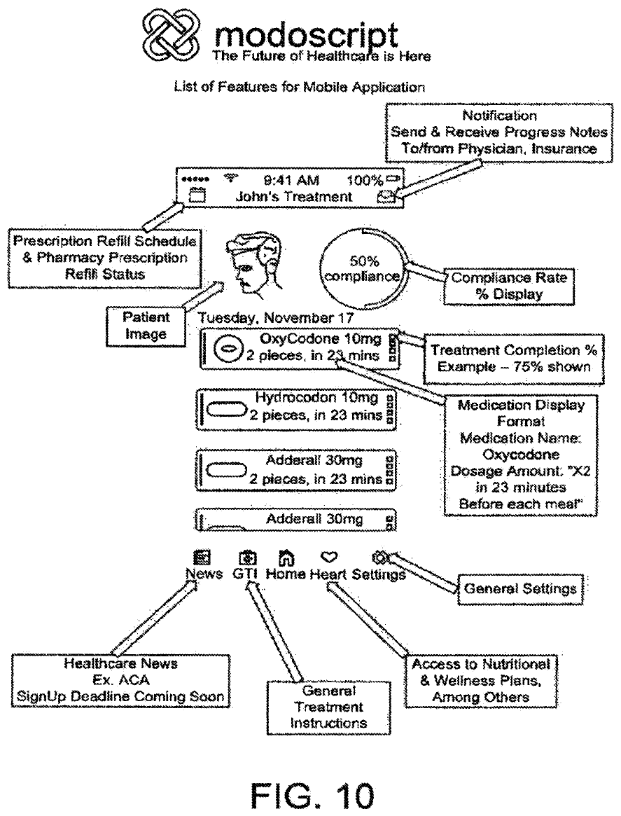

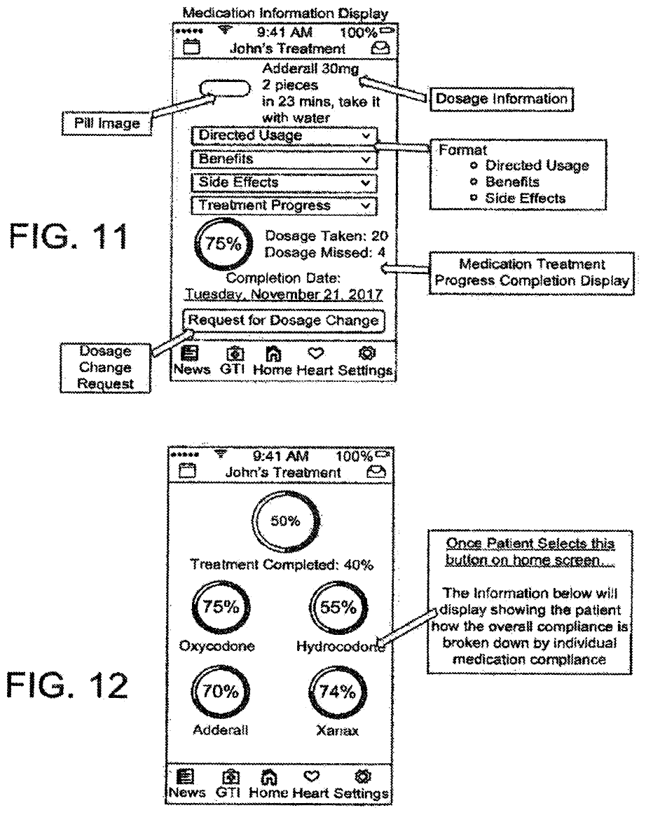

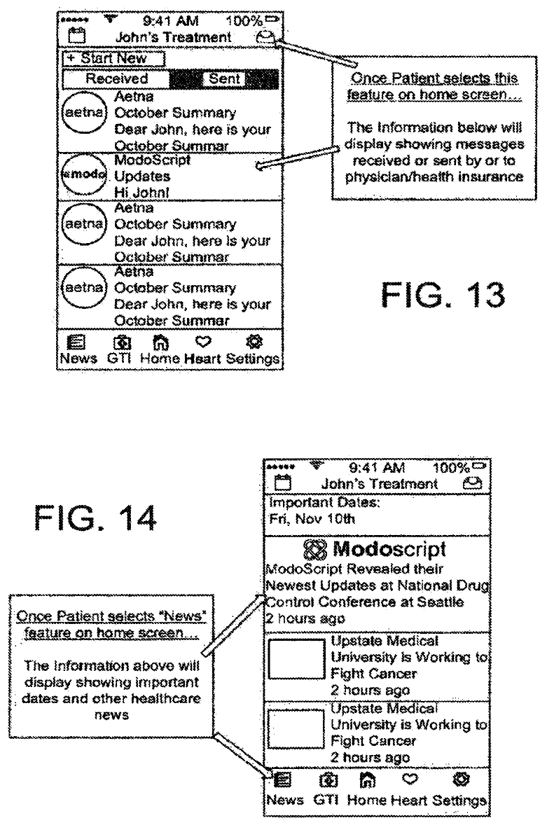

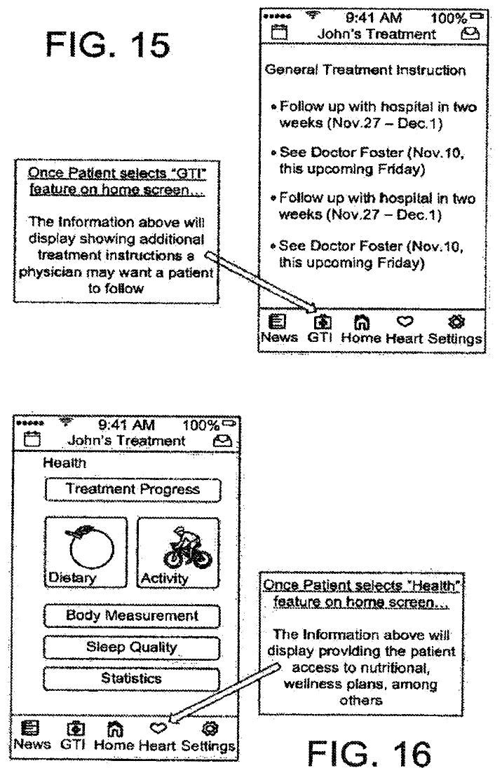

FIGS. 10-16 illustrate some examples of displays or pages of the patient module 70 as shown on a desktop computer monitor. The patient module 70 can provide patients with pre-programmed general and prescription treatment plans. The application can be structured to educate patients more about their respective treatments by providing them with step by step treatment guidance and educational information (e.g., benefits, side effects, and directed usage) for each medication prescribed. A checklist with any additional treatment instructions that physicians may want their patients to follow can also be provided (e.g., “Please visit Neurologist, Dr. Chin”). Furthermore, via the patient module 70, patients can have access to nutritional and wellness plans and/or can be able to receive push notifications from their physicians regarding topics such as, but not limited to, treatment progress, health insurance providers, and appointment reminders). Upon consent, patients can communicate with their physicians or insurance providers, via messaging or video conference (e.g., physician checking up on a patient's prescription treatment progress).

Additionally, in certain embodiments, the patient module 70 can allow patients to request dosage changes depending on how the patients react to their prescription treatment plan, which can require approval from their doctors. In other embodiments, the patient module 70 does not allow patients to request dosage changes. To ensure patient safety and proper treatment guidance, the patient module 70 can send out automated pop-up treatment progress related questions (e.g. “How are you feeling one week into your prescription treatment plan? A. Better B. The Same C. Worse”) at least but not limited to 3 times a week. Other features to better assist patients can include having access to nutritional and wellness plans to further improve the rate of recovery or resolution of their symptoms, and having access to important healthcare related news that might apply to a patient (e.g., “Flu season is around the corner . . . learn more or schedule an appointment with your primary care physician”). The patient module 70 can also display pop-up pharmaceutical ads every 3^{rd}, 4^{th}, or other number of times a patient accesses the patient module 70.

The pill dispenser 12 can communicate via LAN or PAN, such as Bluetooth® or private Wi-Fi®, with a patient's computing device running the patient module 70. The pill dispenser 12 can also communicate to the patient's computing device via cellular network or provider network. Patients without smartphones can access the patient module 70 and its features, such as educational information, progress notes, and dosage change requests, among others, via the internet. Now-known or future-developed security measures can be implemented to assure the correct identity of a patient logging into the patient portal 70 via any computing device.

In cases where a patient fails to take his or her medications as instructed by the prescribing doctor, the pill dispenser 12 can record and send this information through the patient module 70 to the administrator module 78, which can direct that a notification be sent to the cellular device of the patient, the pill dispenser 12, and/or the patient module 70, as well as a text message to the patient's family emergency contact, as an incentive to further combat prescription non-adherence.

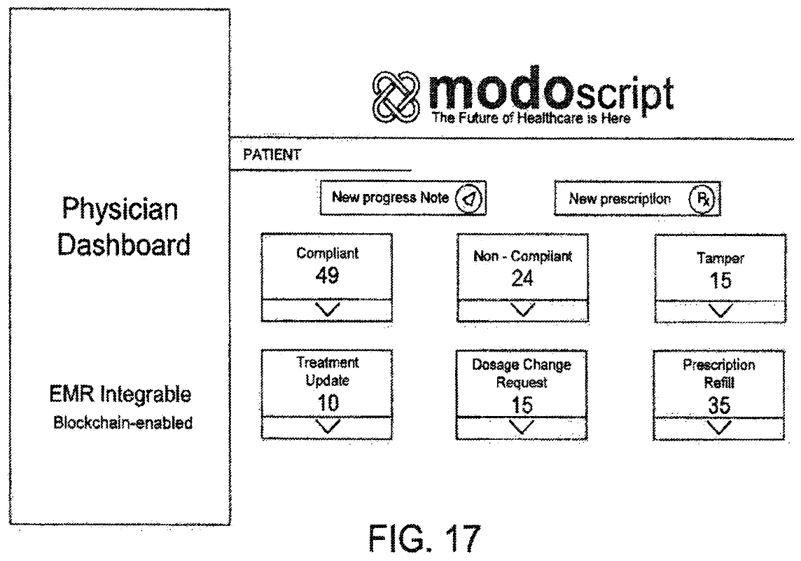

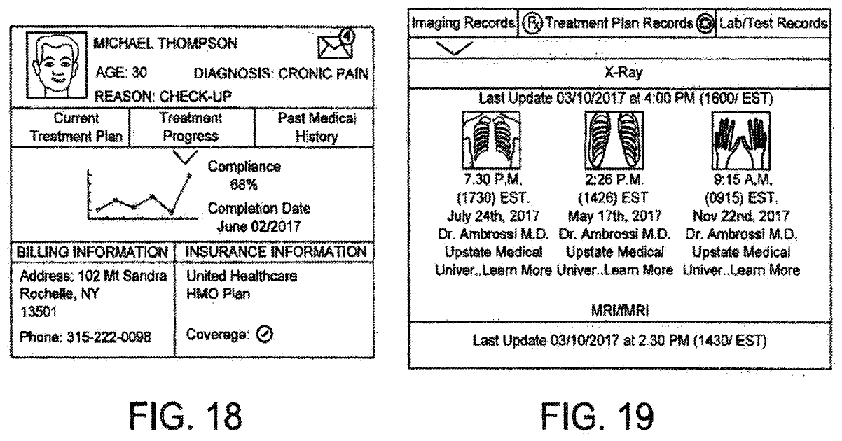

FIGS. 17-19 illustrate some examples of displays or pages of the doctor module 72 as shown on a desktop computer monitor. The doctor module 72 can be accessible as a stand-alone application running on a computing device, or accessible within the Electronic Medical Records (EMR) system that can provide physicians with live monitoring of information of their patients' treatment progress. Through the doctor module 72, doctors can have access to the number and list of patients who are following their treatments accordingly, patients who have missed multiple dosages or who are not being compliant with the checklist of additional treatment instructions, patients who attempt to tamper with the pill dispensing 12, patients who need to have their treatments revised or updated, and patients who request a dosage change. Because the pill dispenser 12 and the dispensing system platform 16 are able to keep track of how many pills are dispensed at any given time, the doctor module 72 can alert physicians prior to any patients' medications running out to facilitate a smooth prescription refilling or renewal process.

The doctor module 72 can provide doctors with access to patient treatment plan records, imaging records, and lab/test records of any particular patient undergoing or who has undergone a general or prescription treatment plan using the pill dispensing system 10. Authorized personnel (e.g., physician, nurse, physician assistant) can have the ability to upload images or lab/test results to the dispensing system platform 16 through the doctor module 72. The doctor module 72 can also retrieve patient imaging records from EMR using algorithms and store the patient imaging records under the patients' personal treatment charts.

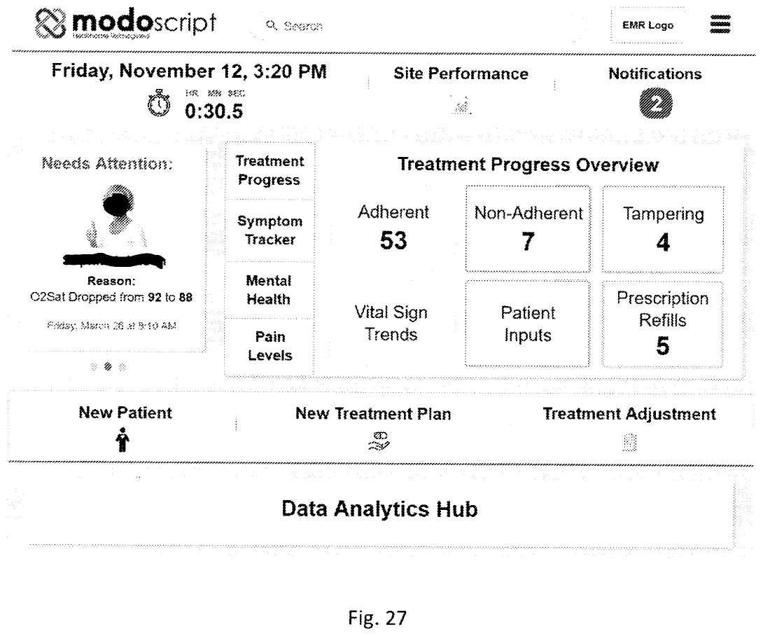

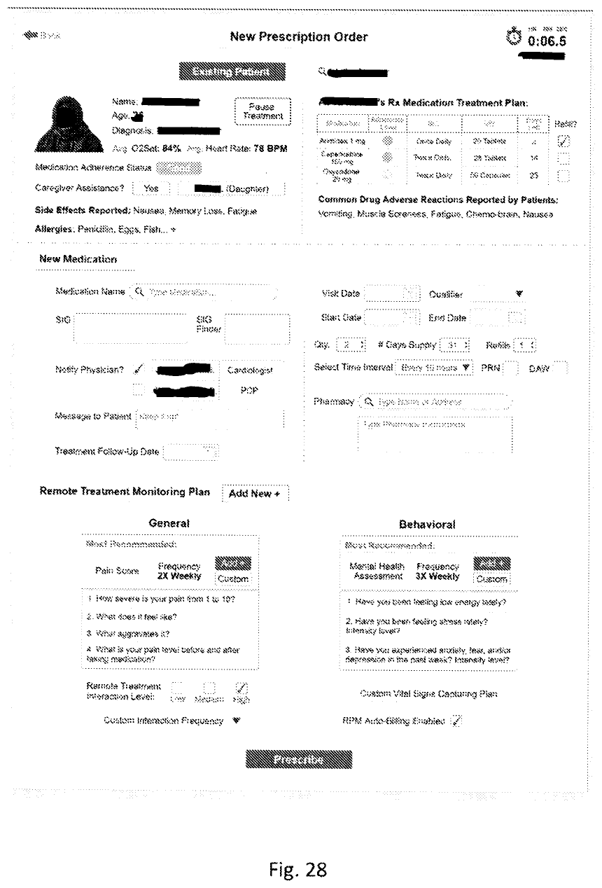

FIGS. 27-28 illustrate alternate examples of displays or pages of the doctor module as shown on a desktop computer monitor. As shown in FIG. 27, the doctor module may include a dashboard or home page. The dashboard may provide a summary of a patient's treatment plan and treatment progress. The summary may include information from one dispensing device or a plurality of dispensing devices associated with the user. A variety of modules may be accessed through the dashboard or home page.

As shown in FIG. 28, the doctor module may display a patient's treatment plan, including several medications each associated with its own dispensing device. Thus, a plurality of dispensing devices may be controlled via one doctor module. The doctor module may display general and behavioral information of the patient. The doctor module may include a questionnaire for the doctor to provide an authorized instruction for a new medication or prescription. The new medication or prescription may be associated with a new dispensing device. The doctor module may include a questionnaire for the doctor to revise an existing authorized instruction, for example, responsive to behavioral or health data received from a dispensing device or other biometric sensor associated with the patient.

As shown in FIG. 28, the doctor module may additionally include a remote treatment monitoring plan. The remote treatment monitoring plan may include a menu of exemplary questions to be communicated to the patient via the display screen of the device or patient module. The doctor module may require responses to the exemplary questions from the patient before allowing authorization of a new medication or revision of an existing treatment plan. The questions may prompt a patient to provide general information, such as pain score, pain levels, and other symptoms. The questions may prompt a patient to provide behavioral information, such as a mental health assessment or other behavioral symptoms. The questions to be communicated to the patient may be customizable by the doctor.

The pharmacist module 74 can provide pharmacists with real-time patient treatment data analytics (medication name, participant name, device identification code (e.g., IQR#), number of pills dispensed, time, date, location, and fingerprint verification) and a list of participants who are compliant, who are not compliant, who attempt to tamper with the pill dispenser 12, and whose medications are running low. The pharmacist module 74 can include a message board with feedback from patients along with additional data collected from surveys through the dispensing system platform 16. The pharmacist module 74 can rate patients based on compliance percentage and can provide pharmaceutical companies with additional clinical trial data analytics. The third-party module 76 can be used and/or configured for use by a variety of third parties to interact with the pill dispenser 12, the dispenser key device 14, and/or the other parts of the dispensing system platform 16. For example, subject to privacy ethics and laws, health insurance providers can use the third party module 76 to access patient treatment and general patient population data analytics of any medication flowing through the market. Insurance providers can also have access to compliance rates and additional statistics of any individual member or of any desired population. This data can be broken down by state, region, county, town, sex, gender, condition, etc.

In another example, the third party module 76 can be configured for access by a government agency, such as, but not limited to the U.S. Department of Health, NIH, CDC, and FDA. Through the third party module 76, the government agency can access patient treatment data analytics broken down by state, region, county, town, sex, gender, condition, etc. The data can be kept anonymous and restricted from individual treatment data.

Data from all insurance providers and Medicare/Medicaid can be bundled together and available for government agencies to have live statistics of the general flow of any medication, broken down by compliance rates, tampering statistics, population data broken down by age (e.g., missed dosages, tampering, etc.).

In another example, the third party module 76 can provide pharmaceutical companies with real-time access to pharmaceutical supply chain data of the different medications offered to patients to ensure proper protocol is followed, and allow for further improvement to reduce costs. This data can also be used by pharmaceutical companies to buy ad space, and have access to data analytics on consumer outreach via targeted pharmaceutical ads. Medication treatment progress data (e.g., time of dosage, dosage amount dispensed, extra dosages dispensed, tamper alerts, etc.) received for each patient can be saved in the cloud-based database, and can be accessible to one or more specified pharmaceutical companies through the third party module 76. Medication data provided can be used by pharmaceutical companies, for example, to study the causation of side effects, which can then assist the pharmaceutical companies to develop safer medications for patients.

Thus, a cloud-based database of the dispensing system may be in communication with the computer processor. In use, the cloud-based database is generally operable to transmit the authorized instruction, including the predetermined schedule, to the device via the communication element. The computer processor may be programmed to operate the dispensing device in response to the authorized instruction.

The communication element may further be programmed to transmit data, including one or more of the biological data, behavioral data, dispensing device data (including actual usage of the dispensing device), medication treatment progress data, and the authorized instruction to the cloud-based database. The dispensing system platform, responsive to receiving the data from the cloud-based database, may be capable of revising the authorized instruction.

The cloud-based database may have access to supplemental data from the user. The supplemental data may be self-reported by the user, for example, via the patient portal. In some embodiments, the supplemental data may be provided by a wearable device, such as a smart watch or fitness tracker, or a cloud application, such as a health or fitness application. The supplemental data may include any additional data about the patient's health, habits, or activity. Exemplary supplemental data includes, for example, biological information of the patient, such as age, body mass index (BMI), medical history (e.g., comorbidities, chronic conditions, allergies, adverse reactions), family history, genetic information; geographic location of the patient (home or current location); treatment information of the patient, such as current or past dosage or medication regiment, concurrent medications, previous positive outcomes; lifestyle factors, such as diet, exercise, sleep patterns, and stress levels; symptoms experienced by the patient, such as side effects, pain score, or energy levels; and mental health information of the patient. The dispensing system platform, responsive to receiving the supplemental data from the cloud-based database, may be capable of revising the authorized instruction.

The supplemental data may be provided to a doctor or pharmacy, or made accessible to the doctor or pharmacy, for example, via the doctor or pharmacy module. The doctor or pharmacy may use the supplemental data to revise the authorized instruction. In some embodiments, the doctor or pharmacy may use the supplemental data to make recommendations to the patient. For example, the doctor or pharmacy may review a geographic location of the patient and recommend a pharmacy location to refill the prescription or automatically refill the prescription on behalf of the patient. In some embodiments, the dispensing system platform may make the recommendation or automatically refill the prescription. The dispensing system platform may ask the patient to confirm their location before refilling the prescription.

The cloud-based database may have access to data from a plurality of devices, from the same user or different users. Thus, a central database may be provided including data collected from one or more user of the device. The dispensing system platform may utilize this data to revise the authorized instruction or provide a recommendation to the doctor or authorized personnel to revise the authorized instruction accordingly. The cloud-based database may store historical data, including data received from previous users of the plurality of devices or from the same user during a previous use of the device. The dispensing system platform may revise the authorized instruction or provide a recommendation to revise the authorized instruction responsive to the historical data. Accordingly, treatment plans may be designed and optimized based on patient data and historical data.

For instance, the data obtained from the communication element or patient portal may be compared and correlated with historical data obtained from other patients. The historical data may include, for example, biometric data, such as biological data, behavioral data, dispensing device data (including actual usage of the dispensing device), medication treatment progress data, biological information of the patient, such as age, body mass index (BMI), medical history (e.g., comorbidities, chronic conditions, allergies, adverse reactions), family history, genetic information; geographic location of the patient (home or current location); treatment information of the patient, such as current or past dosage or medication regiment, concurrent medications, previous positive outcomes; lifestyle factors, such as diet, exercise, sleep patterns, and stress levels; symptoms experienced by the patient, such as side effects, pain score, or energy levels; and mental health information of the patient. The historical data may be stored on the cloud-based database. The authorized instruction may be initially selected or revised to follow a treatment plan of similar patients who ultimately experienced a positive treatment outcome by correlating the patient data with historical data. Furthermore, the authorized instruction may be optimized over time with increasing access to new patient data, which then becomes historical data.

Thus, in certain embodiments, the cloud-based database is in communication with a plurality of dosage unit dispenser caps. Each unit dispenser cap may be associated with a different patient receiving treatment for the same or similar indication with the same or similar medication. In some embodiments, the cloud-based database may be in communication with a plurality of dosage unit dispenser caps prescribed to the same patient. For patients who are prescribed a plurality of medications, the dispensing system platform may be capable of programming or revising the authorized instruction for each dispensing device responsive to the data received from the plurality of dispensing devices. Thus, combination therapies may be optimized by the use of a plurality of devices.

The data may be collected and viewed on the dispensing system platform accessible by the computing network or computing device. For instance, a patient may provide information via the patient platform or a sensor of the device. An administrator, such as a doctor or pharmacist, may review the information provided by the patient via an administrator module, e.g., doctor module or pharmacist module. The administrator may be a health provider selected from a pharmacist, a prescriber, a medical professional, a medical insurance professional, and a caretaker. The administrator may review information provided from one patient or a plurality of patients.

The administrator module may be configured to communicate with the cloud-based database. The cloud-based database may correlate a plurality of data points for a large number of patients globally. For example, the cloud-based database may store and organize biological data, authorized instructions, behavioral data, and medication treatment progress data provided by a network of dispensing devices. The dispensing system platform may be used to provide a recommendation for a treatment plan based on stored historical information from patients that experienced a positive treatment outcome. Furthermore, the dispensing system platform may provide predictive results for treatment of a particular patient based on stored historical information and the patient data.

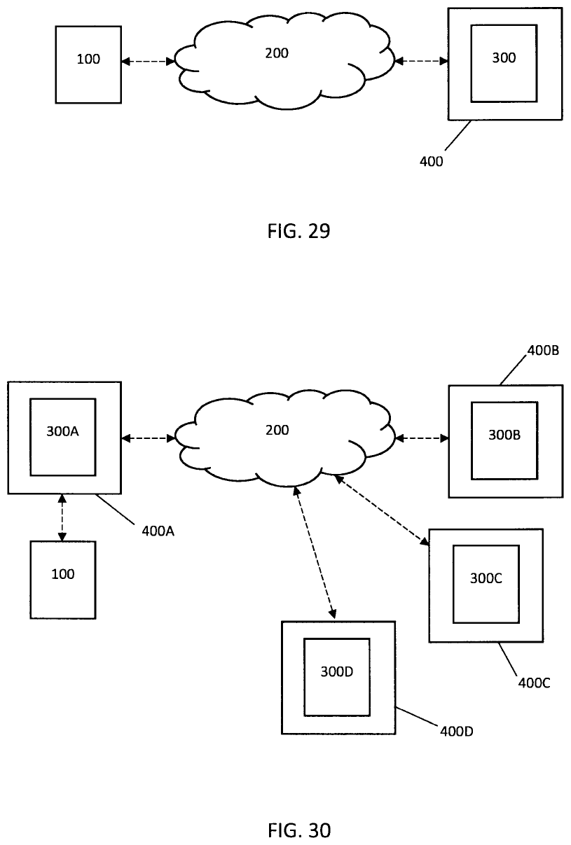

FIG. 29 is a schematic diagram of a system for patient treatment and monitoring as described herein. The system includes a dispensing device 100 having a computer processor connectable to cloud-based database 200. The dispensing device 100 may be directly connectable to cloud-based database 200 via communication element. Dispensing system platform 300, running the various modules as previously described, is connectable to cloud-based database 200 and accessible on a computing device 400. Cloud-based database 200 may store patient data received from the dispensing device 100 and historical data received from a plurality of dispensing devices 100 and dispensing system platforms 300 used by patients globally. Dispensing system platform 300 may be programmed to recommend a treatment regimen or authorized instruction based on the patient data and historical data.

FIG. 30 is a schematic diagram of another configuration for a system for patient treatment and monitoring. In the system of FIG. 30, the dispensing device 100 is connectable to the cloud-based database 200 via dispensing system platform 300A running on computing device 400A. The communication element of the dispensing device 100 may be configurable to connect to computing device 400A. Additionally, cloud-based database 200 may be separately accessible to additional users, such as a doctor, pharmacist or caregiver, via dispensing system platform 300B, 300C, 300D running on computing devices 400B, 400C, 400D. The modules accessible to the patient on dispensing system platform 300A may be different than the modules accessible to the doctor, pharmacist, or caregiver on dispensing system platform 300B, 300C, 300D. However, the modules of dispensing system platform 300A, 300B, 300C, 300D may work together to provide the health data from the patient to the doctor, pharmacist, or caregiver, the recommendation as calculated by the dispensing system platform 300A, 300B, 300C, 300D using data from the cloud-based database 200 to the doctor or pharmacist for the treatment plan, and the authorized instruction from the doctor or pharmacist to the patient.

Accordingly, the data stored on the cloud-based platform may include any one or more of patient data and historical data, including health information, biometric readings, self-reported data, and demographic information, as previously described; medication information, including the treatment plan and authorized instruction; device activity and device control, including dispensing activity, tampering, mechanical failures and pill jams; and connected third party information, including greater population data and pharmacy information. The data stored on the cloud-based platform may be used by the dispensing system platform to provide any one or more of treatment plan personalization; predicted disease progression and predicted outcomes; drug design, clinical trial progression and regulatory approval, and drug to market acceleration; pharmacogenomics; treatment adherence rates; malpractice liability protection; remote treatment support and optimizing remote patient monitoring CPT codes; improving and expanding Healthcare Effectiveness Data and Information Set (HEDIS); enforcement of value based contracts; improving quality of ratings; streamlining patient charting; supply chain optimization; and additional predictive analytics.

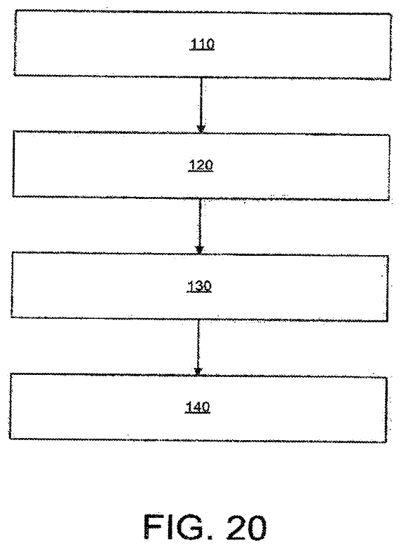

FIG. 20 is a flow chart showing prescription flow via the pill dispensing system 10. In a first step, (Step 110), the pill dispensing system 10 can require electronic prescription order and treatment instructions. These prescription order and treatment instructions can be input through the doctor module 72. At the time the doctor or authorized personnel (e.g., physician's assistant, nurse) sends an electronic script to a pharmacy, he or she can be prompted to answer one or more simple questions via the doctor module 72. The questions can be provided using drag down or check boxes, or another format, to program the desired treatment plan. Some examples of questions include:

1. Length of treatment plan (e.g., 30 days, 60 days, etc.);

2. Method of dispensing upon biometric sensor verification, dispensing button, or both;

3. Dosage amount to be dispensed (e.g., 1 pill, 2 pills, etc.);

4. Desired time interval between dosages (e.g., 4 hours, 8 hours);

5. Number of extra dosages or pills allowed (1, 2, 3, etc.);

6. In how long would you like to check back on [patient name]'s prescription treatment plan (5 days, 1 week, 2 weeks, etc.); and

7. General Treatment Plan Instructions—enter instructions manually or fill-in using check box, or drop down options.

After this information is submitted, this information and the prescription information can be saved on the administrator module 78 and the electronic script can be sent to a designated pharmacy, to the pharmacist module 74 residing on a computing device or computing network at the designated pharmacy, to the dispenser key device 14, and/or to the auto-refilling machine used for regular prescription filling purposes.

In step 120, the pill dispensing system 10 can facilitate filling of the pill dispenser 12 according to the prescription. The prescription order and treatment instructions can be conveyed to the pharmacist module 74, to the dispenser key device 14, or otherwise to the pharmacy, and the pill dispenser 12 can be filled, either automatically by a refilling machine or manually. An auto-refilling machine can fill the vial 24, or the vial 24 can be filled manually by a pharmacist based on the prescription order information received and displayed by, for example, the display 83 of the dispenser key 14.

At a “verification and batching” stage, the cap 22 can be connected to (e.g., twisted onto) the filled vial 24 until the primary locking element 60 is activated. This activation of the primary locking element 60 can activate the pill dispenser 12 to instruct the pharmacist via a pre-programmed voice message (e.g. “Please verify or make sure that the prescription is filled properly prior to twisting the cap onto the secondary locking mechanism”), and to flash a color-coded array of colors (e.g., blue, white, and red).

Upon completion of “verification and batching”, the cap 22 can be connected (e.g., twisted) further to engage the secondary locking element 62. As discussed above, when the secondary locking element 62 is engaged, a second indicator (e.g., a sound or light, such as but not limited to a “click” or LED illuminating) is activated. Additionally, the alignment indicators on the cap 22 and the vial 24 can be aligned when the secondary locking element 62 is engaged.

In step 130, the pill dispensing system 10 can require activating the pill dispenser 12 for patient use. The pill dispensing system 10 can accept input indicating that the filled pill dispenser 12 is picked by or delivered to the patient. The pharmacist can enter this information to the pill dispenser 10, the dispenser key device 10, the pharmacist module 74, or the pharmacist's separate system if it is accessible to the pill dispensing system 10. As a result of the pill dispensing system 10 receiving the information that the filled pill dispenser 12 is picked up by or delivered to the patient, the pill dispensing system 10 can create an access code for the patient to have access to his or her prescription treatment plan. The access code can be sent to the patient via text, email, call, or other means. This access code can be required only for first-time patients, or for first-time and returning patients. In some embodiments, returning patients can have automatic access to their treatment plans through the patient portal 70 and/or the pill dispenser 12. In some embodiments, it may still be the case that attempts to change the treatment plan, such as requesting a dosage change, will require a secret pin, password, or fingerprint for patient identity verification purposes. In other embodiments, the system may not accommodate attempts to change the treatment plan by the patient and/or pharmacist.

The patient can be required to download the patient module 70 in order to use the pill dispenser 12. The patient module 70 and/or the pill dispenser 12 can require the patient to provide a social security number, and/or a security code which can be provided to the patient by email or mobile device. Alternatively, other now-known or future-developed security features to verify the patient identify can be implemented. Proper identity verification can grant the patient access to the general and prescription treatment plan information for the patient.

The patient can then have the opportunity to select a preferred language (English, Spanish, French . . . ) for the course of the treatment plan, applying that choice to the patient module 70. The patient module 70 can inform the pill dispenser 12 (or vice versa) to also communicate with the patient in the chosen language. General treatment plan instructions can remain in the same language submitted by the doctor or authorized personnel, when different, or both languages can be included. For instance, if the patient selects Spanish as the primary language of choice, at the time the patient is instructed by the patient module to biometrically verify the patient's identity, upon successful verification, the pill dispenser 12 can acknowledge the language choice. For example, the pill dispenser 12 can say, “Huella Digital Guardada”.

The patient module 70 or the pill dispenser 12 can also direct the patient to record biometric information. For example, the patient module 70 can direct the patient to record a fingerprint by placing a thumb on a fingerprint reader located on the pill dispenser 12. The pill dispenser 12 can indicate successful biometric information recording. For example, the pill dispenser 12 can play or generate a voice message saying something like, “Fingerprint Recorded”, and/or the indicator lights 46 can illuminate a specified color or color pattern. If the biometric information is not successfully recorded, the indicator lights 46 can illuminate a different specified color or color pattern, and/or a different voice message can be generated, such as, “Please try again”. Alternatively, the dispenser key device 14 can be required and/or used to record the biometric information using the biometric recorder 61. This alternative can facilitate avoiding instances where an improper or unintended person records biometric information because it enables a pharmacist to observe and control the biometric recording. Upon successful biometric information recording, patients can be required by at least one of the pill dispenser 12, the patient module 70, or the dispenser key device 14 to select when they would like their prescription treatment plan to start, whether it is in 30-min, 1 hour, 2 hours, 1 day, etc. after picking up their prescription. Failure to select a prescription treatment start time can cause the dispensing system platform 16 to send notifications to the patient's phone and/or email, or other patient accounts. In other embodiments, the doctor or pharmacist may select when the treatment plan will start.

Upon completing the registration and set up steps, patients can be given access to their general and prescription treatment plan, and the treatment plan can start alerting patients, depending the prescription treatment start time. In general, a pill may only be dispensed from the device responsive to one or more input requirements programmed on the device with the authorized instruction. For instance, the device may be enabled to dispense a pill responsive only to verification of identification of the user, timing is within an authorized window of the predetermined treatment schedule, appropriate health data is collected from the user, and/or the user positively responded to one or more required questions.

Notably, the pill dispenser 12 can be configured to perform any function described herein as being performed by the patient module 70, accessible by a computing device in use by the patient. The pill dispenser 12 and the patient module 70 may be in communication via the communication element of the device. Alternatively or additionally, the pill dispenser 12 may be configured to perform any function described herein as being performed by a wearable or external device in use by the patient. The wearable or external device may be in communication with the pill dispenser 12 via the communication element.

In step 140 the pill dispensing system 10 can facilitate refilling of prescriptions. The dispensing system platform 16 can alert the patient via the patient module and/or the pill dispenser 12, via text message, via email, or other form of communication when a refill script is sent to the pharmacy. From there, based on the phone's location, patients can have the option to select a pharmacy of their choice around their current location or select the primary pharmacy of choice that they have saved on their prescription treatment chart.

For prescription refilling purposes using mail order service, at the time patients originally receive their prescription order, along with the prescription order, there can be a prepaid bubble mailer padded envelope which patients can use to package the used pill dispenser 12 for return shipping or transportation. As a result of the dispensing system platform 16 receiving a notification that the used pill dispenser 12 is returned, the insurance provider can receive a partial reimbursement for the pill dispenser 12.

Methods of facilitating distribution of a dosage unit are disclosed herein. The methods generally include providing one or more of the dosage unit dispenser cap, the vial loaded with the dosage unit, the dispensing system platform, and/or the computing network or computing device. The methods may include providing instructions to execute any one or more of the actions described herein. For instance, the methods may include providing instructions to mate the cap with the vial to form the internal storage cavity, wherein the internal storage cavity is loaded with an effective amount of the dosage unit to complete a prescribed regimen.

The methods may include filling the vial with the effective amount of the dosage unit and mating the vial with the cap to form the internal storage cavity. The methods may further include locking the vial to the housing.

The methods may include providing instructions to transmit the authorized instruction including the predetermined schedule to the communication element. The authorized instruction may be provided and/or transmitted through the administrator portal. After providing the instructions, and after use of the device by a patient, the methods may include receiving data including one or more of the biological data, behavioral data, medication treatment progress data, and the authorized instruction from the device. The method may be received and/or reviewed through the administrator portal. The methods may include revising the authorized instruction responsive to the data. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

The function and advantages of these and other embodiments can be better understood from the following example. The example is intended to be illustrative in nature and not considered to be limiting the scope of the invention.

### Prophetic Example: Patient Treatment Monitoring System Data-map

The dispensing device disclosed herein may be used in a patient treatment monitoring system. Several industry stakeholders may benefit from the data collected and stored in the central database. Industry stakeholders were identified as healthcare companies and healthcare providers (including primary care providers, specialized care providers, home care companies, etc.), pharmaceutical companies (such as drug design and clinical research organizations), health insurance companies, and pharmacy distribution partners.

Table 1 summarizes the data collected by the dispensing device and other devices and applications connectable to the central database. The data can be used in any of the programs listed in Table 2. However, Table 2 also correlates certain programs with specific industry stakeholders who may benefit from such programs.

TABLE 1
Data Collected and Stored on the Central Database

| Data | Collection Method |
|---|---|
| Medication information, | Reported via the doctor or pharmacist |
| including medication and dosage | module |
| Patient health information, | Reported via connectable health |
| including medical history, | application or electronic medical |
| family history, chronic or | record |
| concurrent conditions, and | |
| additional medication | |
| Biometric readings | Reported via biometric sensing module |
| | or wearable device |
| Patient self-reporting data, | Reported via patient module |
| including symptoms, side | |
| effects, and mental health | |
| Demographic information, | Reported via patient module, |
| including age, gender, and | connectable health application, |
| BMI | or electronic medical records |
| Genetic information | Reported via connectable health |
| | application or electronic medical |
| | records |
| Patient lifestyle, including | Reported via patient module, |
| diet, physical activity, and | connectable health application, or |
| sleep patterns | electronic medical records |
| Pharmacy information | Reported via doctor or pharmacist |
| | module |
| Device activity | Reported via dispensing device |
| Device control | Reported via doctor or pharmacist |
| | module |

TABLE 2
Programs Developed with Data Stored on Central Database

| Program | Interested Stakeholder |
|---|---|
| Treatment Plan Personalization | Healthcare companies, |
| | pharmaceutical companies |
| Disease progression | Healthcare companies, |
| | pharmaceutical companies |
| Pharmacogenomics | Healthcare companies, |
| | pharmaceutical companies |
| Treatment/medication adherence | Healthcare companies, |
| | pharmaceutical companies, |
| | health insurance companies, |
| | pharmacy distribution partners |
| Malpractice/liability protection | Healthcare companies, |
| | health insurance companies, |
| | pharmacy distribution partners |
| Provider network efficiencies | Healthcare companies |
| Remote treatment support | Healthcare companies |
| Streamline charting | Healthcare companies |
| Increased RPM CPT payments | Healthcare companies |
| Improve HEDIS measurements | Healthcare companies, |
| | health insurance companies |
| Predictive analytics for drug | Pharmaceutical companies |
| development, clinical trials | |
| Drug to market acceleration | Pharmaceutical companies |
| Regulatory (e.g., FDA) | Pharmaceutical companies, |
| efficacy data requirements | health insurance companies |
| Provider risk management | Health insurance companies |
| Enforcement of value-based | Health insurance companies |
| contracts | |
| Improved quality ratings | Health insurance companies |
| Regulatory compliance | Pharmacy distribution partners |
| Inventory management | Pharmacy distribution partners |
| Supply chain optimization | Pharmacy distribution partners |

Accordingly, data collected by the dispensing device, other devices, and applications connectable to the central database will be stored and used in a variety of programs from which several industry stakeholders may benefit. The data will be used to quantify population health patterns or in personalized data analytics including, for example, predicting treatment outcomes and general health trends. The platform will utilize proprietary algorithms to produce predictive analytics based on the collected data and historical data.

What is claimed is:

1. A dosage unit dispenser cap in communication with a biometric sensing module comprising at least one biometric sensor configured to collect biological data of a user including identity verification data and health data, the dosage unit dispenser cap comprising:
a housing defining an open-ended cavity configured to mate with a standard prescription dram vial forming an internal storage cavity loaded with the dosage unit;
a dispensing port on the housing to dispense the dosage unit from the internal storage cavity, the dispensing port locked by a locking element and configured to be enabled to dispense the dosage unit by the user responsive to activation of the biometric sensor verification of the identity of the user and on a predetermined schedule;
a computer processor supported by the housing in communication with the biometric sensing module, a memory that stores the biological data of the user, and a communication element that receives authorized instruction including the predetermined schedule.

2. The dosage unit dispenser cap of claim 1, wherein the at least one biometric sensor is supported by the housing.

3. The dosage unit dispenser cap of claim 1, wherein the at least one biometric sensor is a wearable device or a mobile device.

4. The dosage unit dispenser cap of claim 1, wherein the housing is configured to lock with the standard prescription dram vial.

5. The dosage unit dispenser cap of claim 1, further comprising a vial adapter configured to mate the standard prescription dram vial with the open-ended cavity of the housing.

6. The dosage unit dispenser cap of claim 5, wherein the vial adapter is dimensioned to mate with a selected size of the standard prescription dram vial and interchangeable with another vial adapter.

7. The dosage unit dispenser cap of claim 5, wherein the vial adapter is variable to mate with more than one size of the standard prescription dram vial.

8. The dosage unit dispenser cap of claim 1, being in communication with one biometric sensor configured to collect the biological data of the user including both the identity verification data and the health data.

9. The dosage unit dispenser cap of claim 1, being in communication with at least two biometric sensors configured to collect the biological data of the user including the identity verification data and the health data.

10. The dosage unit dispenser cap of claim 1, wherein the biometric sensor is one or more of a touch-activated biometric sensor, a sound-activated biometric sensor, a visual biometric sensor, and a breath particulate biometric sensor.

11. The dosage unit dispenser cap of claim 10, wherein the touch-activated biometric sensor is capable of sensing one or more of: fingerprint, heart rate, blood oxygen saturation, breathing rate, temperature, blood glucose level, skin capacitance, and viral or respiratory infection or a symptom thereof.

12. The dosage unit dispenser cap of claim 10, wherein the sound-activated biometric sensor is capable of sensing one or more of: voice and breathing pattern.

13. The dosage unit dispenser cap of claim 10, wherein the visual biometric sensor is capable of sensing one or more of ocular, facial, or other features, and temperature.

14. The dosage unit dispenser cap of claim 10, wherein the breath particulate biometric sensor is capable of sensing one or more of: blood alcohol content (BAC), tetrahydrocannabinol (THC) content, blood glucose level, and viral or other pathogenic load.

15. The dosage unit dispenser cap of claim 1, wherein the memory is a cloud-based data storage.

16. The dosage unit dispenser cap of claim 1, wherein the memory is a local memory storage device supported by the housing.

17. The dosage unit dispenser cap of claim 1, wherein the communication element is supported by the housing, the communication element being configured to facilitate communication between the computer processor and a central database by direct connection or wireles sly over cellular network, provider network, local area network, personal area network, or other wireless network, the central database being in communication with a dispensing system platform configured to transmit the authorized instruction including the predetermined schedule to the communication element.

18. The dosage unit dispenser cap of claim 17, wherein the communication element is configured to transmit data to the central database, including one or more of the biological data, behavioral data, dosage unit dispensing data, and medication treatment progress data.

19. The dosage unit dispenser cap of claim 18, wherein the central database is in communication with a dispensing system platform configured to notify the administrator to review the data and/or revise the authorized instruction responsive to the data.

20. The dosage unit dispenser cap of claim 17, wherein the communication element is configured to receive data including the authorized instruction and the central database is in communication with a dispensing system platform configured to notify the user of the authorized instruction.

21. The dosage unit dispenser cap of claim 1, further comprising a dispensing mechanism in communication with the computer processor configured to selectively direct a predetermined number of the dosage unit to the dispensing port.

22. The dosage unit dispenser cap of claim 21, wherein the dispensing mechanism is dimensioned to correspond with one or more selected pill sizes.

23. The dosage unit dispenser cap of claim 22, wherein the one or more selected pill sizes are selected from 5 to 000.

24. The dosage unit dispenser cap of claim 22, wherein the dispensing mechanism is interchangeable with another dispensing mechanism.

25. The dosage unit dispenser cap of claim 21, wherein the dispensing mechanism is configured to selectively direct one dosage unit to the dispensing port.

26. The dosage unit dispenser cap of claim 21, wherein the dispensing mechanism comprises an adapter configured to selectively direct the predetermined number of dosage units to a stage car in communication with the dispensing port.

27. The dosage unit dispenser cap of claim 21, wherein the dispensing mechanism is operatively connected to a motor configured to rotate the dispensing mechanism delivering the predetermined number of dosage units to the dispensing port.

28. The dosage unit dispenser cap of claim 27, further comprising a rotational sensor in communication with the computer processor and configured to determine clocking of the dispensing mechanism.

29. The dosage unit dispenser cap of claim 21, further comprising a load sensor in communication with the computer processor and configured to determine if the dispensing mechanism has loaded the predetermined number of dosage units.

30. The dosage unit dispenser cap of claim 1, further comprising a rechargeable power source supported by the housing operatively connected to the motor.

31. A system for patient treatment and monitoring, comprising:
a dosage unit dispensing device in communication with a biometric sensing module comprising at least one biometric sensor configured to collect biological data of a user;
a central database in communication with the dosage unit dispensing device and the biometric sensing module, the central database storing the biological data of the user, dosage unit dispensing data of the user, and historical data; and
a dispensing system platform in communication with the central database, the dosage unit dispensing device, and the biometric sensing module, the dispensing system platform programmed to recommend a predetermined treatment plan responsive to the biological data of the user and the historical data, and transmit an authorized instruction including the predetermined treatment plan to the dosage unit dispensing device.

32. The system of claim 31, wherein the at least one biometric sensor is supported by a housing of the dosage unit dispensing device.

33. The system of claim 31, wherein the at least one biometric sensor is a wearable device or a mobile device.

34. The system of claim 31, wherein the dosage unit dispensing device comprises a communication element connectable to the central database by a cellular network.

35. The system of claim 31, wherein the dosage unit dispensing device comprises a communication element connectable to the central database by a provider network.

36. The system of claim 31, wherein the dosage unit dispensing device comprises a communication element connectable to the central database by a local area network or personal area network of a computing device.

37. The system of claim 31, wherein the biological data of the user comprises one or more of heart rate or irregular rhythm, cardiac electrical signals, skin temperature, body temperature, skin conductance, sweat rate, breath particulates, oxygen saturation, and voice characteristics.

38. The system of claim 37, wherein the central database further stores supplemental data of the user comprising one or more of age, body mass index (BMI), medical history, family history, genetic information, geographic location, current or past dosage or medication regiment, concurrent medications, previous positive outcomes, lifestyle factors, symptoms, and mental health.

39. The system of claim 38, wherein the dispensing system platform is programmed to provide a predicted treatment outcome responsive to the biological data of the user, the supplemental data of the user, and the historical data.
